(19) United States
(12) Patent Application Publication
(10) Pub. No.: US 2012/0003402 A1
(43) Pub. Date: Jan. 5, 2012

(54) Retardation Film Produced by Using Cellulose Derivative

(75) Inventors: Yoshitaka Ohashi, Kita-Ku (JP); Kouichi Tanaka, Kita-Ku (JP); Hideyoshi Fujisawa, Kita-Ku (JP)

(73) Assignees: POLATECHNO CO., LTD., Niigata (JP); NIPPON KAYAKU KABUSHIKI KAISHA, Tokyo (JP)

(21) Appl. No.: 13/220,027

(22) Filed: Aug. 29, 2011

Related U.S. Application Data
(63) Continuation-in-part of application No. 11/884,290, filed on Aug. 14, 2007.

(30) Foreign Application Priority Data
Feb. 22, 2005 (JP) JP2005-045436
Feb. 28, 2005 (JP) JP2005-053875
Feb. 28, 2005 (JP) JP2005-053895

(51) Int. Cl. C09K 19/00; C08B 3/10; C08F 22/22; C08B 15/10; B32B 9/04; B32B 27/32

(52) U.S. Cl. 428/1.1; 428/411.1; 428/220; 526/238.21; 536/63

(57) ABSTRACT

The present invention relates to a retardation film having biaxial characteristics or an achromatic property, which is obtained by uniaxially stretching of a film composed of cellulose derivatives in which a hydroxyl group of cellulose is substituted by an acyl group having 5 to 20 carbon atoms, preferably 7 to 20 carbon atoms, more preferably 8 to 20 carbon atoms or cross-linked compounds of cellulose derivatives, said retardation film is a superior retardation film which has negative birefringence and excellent optical characteristics and also can be easy to obtain by uniaxially stretching, and in addition, the heat resistance, tearing strength and the like which are weaknesses of cellulose ester are improved.

This application is a continuation-in-part of U.S. Ser. No. 11/884,290 filed Aug. 14, 2007, which is a §371 of PCT/JP2006/303059 filed Feb. 21, 2006, the disclosures of which are incorporated herein by reference.

### TECHNICAL FIELD

The present invention relates to a retardation film produced by using a cellulose derivative useful for image display devices such as liquid crystal display devices and an optical film produced by using the same, and a liquid crystal display device excellent in visible angle properties and the like by using these films.

### BACKGROUND OF THE INVENTION

CRT (Cathode Ray Tube) has been used in large part as a display device, but recently liquid crystal display devices are widely used in different circumstances for PC screens, TV sets, cellular phones, in-vehicle monitors and the like. And display device performance such as high contrast, wide visible angle characteristics and higher durability are required.

For typical liquid crystal display devices, retardation films are used in addition to liquid crystal cells and polarizing plates. Because liquid crystal display devices have a problem of visible angle dependency that use of liquid crystal materials having anisotropy and polarizing plates alone leads to deterioration of display performance when seen from an oblique angle even though good display can be performed when seen from the front, retardation films are used for its improvement.

Retardation films have functions to convert linearly polarized light into circularly polarized light or elliptically polarized light and to change linearly polarized light in a certain direction toward another direction (optical rotation). By using these functions, it is possible to improve, for example, visible angle, contrast and the like of liquid crystal display devices. This retardation film can be usually obtained by uniaxially or biaxially stretching such plastic films as polycarbonate, polyallylate and polyether sulfone. In this instance, birefringence is generated due to anisotropy in refractive index generated by stretching, and hence the film works as a retardation film. Optical performance of a retardation film can be determined by retardation value which is calculated from a difference between a refractive index in the slow axis direction (a direction in which refractive index in the plane becomes the largest) and a refractive index in the fast axis direction (a direction orthogonal to the slow axis direction in the plane) along the front direction of the retardation film at a certain wavelength multiplied by a thickness of the retardation film. However, the retardation value exhibits so-called wavelength dependency (wavelength dispersion characteristics) and visible angle dependency (visible angle characteristics), and the retardation film is used for various types of display devices considering comprehensive performances including these various characteristics.

The wavelength dispersion characteristics mean wavelength dependency of retardation value and differ depending on a type of material to be used, and a retardation film produced from such plastic films as polycarbonate, polyallylate and polyether sulfone as materials has the characteristics that the retardation value on the wavelength side longer than 550 nm is smaller than the retardation value at a wavelength of 550 nm and the retardation value on the wavelength side shorter than 550 nm is larger than the retardation value at a wavelength of 550 nm.

Accordingly, even if a retardation value at a wavelength of 550 nm is adjusted for 137.5 nm to produce a quarter wavelength retardation film, the retardation on the wavelength side longer than 550 nm becomes ¼ or less of the wavelength, and the retardation on the wavelength side shorter than 550 nm becomes ¼ or more of the wavelength.

This poses, for example, the problem that when a retardation film having a retardation which is ¼ of the wavelength (so-called quarter wavelength plate) is used to produce an anti-reflection filter, a sufficient anti-reflection effect is obtained only in the wavelength range where the retardation is almost ¼ of the wavelength and circularly polarized light is converted into elliptically polarized light at other wavelengths resulting in that only insufficient anti-reflection effect is obtained. Also, when a retardation film having a retardation which is ½ of the wavelength (so-called half wavelength plate) is used to produce a rotary polarizer which is used for a liquid crystal projector and the like, only in the wavelength range where the retardation is almost ½ of the wavelength can rotate a linearly polarized light as linearly polarized light, and linearly polarized light is converted into elliptically polarized light at other wavelengths, resulting in that only an insufficient rotary polarizing effect is obtained.

A retardation film having such wavelength dispersion characteristics as impart the same level of retardation to a wavelength through the whole range of visible region is called as an achromatic retardation film, and it is necessary to exhibit such tendency (achromatic property) that, for example, the retardation value on the longer wavelength side is larger than the retardation value at a wavelength of 550 nm and the retardation value on the shorter wavelength side is smaller than the retardation value at a wavelength of 550 nm. As a method to produce such a retardation film, for example, a method is proposed in which a plurality of stretched films are laminated with their optical axes being crossed over with each other, as described in Patent Literature 1. Further, a retardation film is proposed, which is produced by using cellulose acetate obtained by hydrolyzing cellulose triacetate as a polymer to produce a retardation film and can impart the same level of retardation to each wavelength in a wide range of the visible region by using only one film, as described in Patent Literature 2.

On the other hand, visible angle characteristics are angle dependency of retardation value and can be generally controlled by a stretching method of the retardation film. Stretching generates a refractive index, nx, in stretching direction, a refractive index, ny, in direction orthogonal to the stretching direction in a film plane and a refractive index, nz, in thickness direction, and the values determine visible angle characteristics of a retardation film. As uniaxially stretching usually provides a relation, nx>ny=nz, a retardation film has so-called uniaxial characteristics. On the other hand, biaxial characteristics include, for example, cases having a relation of nx>ny>nz, nz≧ny>nx or ny>nz>nx, however, it was not easy to obtain a retardation film having such refractive indexes by generally uniaxially stretching.

For example, in the case of an usual retardation film obtained by uniaxially stretching such a polymer film as polycarbonate, in the case of tilting in the slow axis direction, the retardation value becomes smaller as the tilt angle from the front direction becomes larger, and contrary, in the case of tilting in the fast axis direction, the retardation value becomes larger as the tilt angle from the front direction becomes larger. This tendency is commonly observed in other usual retardation films produced by uniaxially stretching polyallylate, polyether sulfone, cycloolefin polymer such as Zeonor (manufactured by Zeon Corp.) and Arton (manufactured by JSR), and the like. There are such two cases in use of retardation film, one where characteristics that retardation value changes with tilting is utilized and the other one where characteristics that retardation value almost does not change with tilting is utilized, and which characteristics of retardation film to be used depends on a purpose.

As a retardation film with extremely less change of retardation value with tilting, a method for producing a retardation film is disclosed in Patent Literature 3, in which change of retardation value with tilting is controlled by laminating a shrinkable film to a film to be stretched and by uniaxially stretching this for practically biaxially stretching.

In addition, a retardation film is described in Patent Literatures 4 and 5, which has negative refractive index anisotropy excellent in heat resisting properties for the purpose to improve visible angle characteristics of liquid crystal display device.

Further, it is described in Patent Literature 6 that it is possible to offer liquid crystal display devices with the visible angle and the like improved by using a film having optically biaxial characteristics obtained by stretching cellulose ester, specifically cellulose acetate or cellulose acetate having both of an acetyl group and a propionyl group or a butyryl group. This method, however, may cause lower film strength by stretching operation.

Therefore, for improvement of film strength of cellulose derivative, it is described in Patent Literature 7 that tearing strength and folding strength are improved by producing a film from a composition containing cellulose acrylate, specifically cellulose triacetate, a polymerizable monomer and a polymerization initiator.

In Patent Literature 8, a retardation plate is described, which is composed of a polymer films having a retardation value and a refractive index satisfying a specific formula and having a specific thickness, cellulose ester is cited as a polymer, and specifically a retardation plate composed of a cellulose acetate film is disclosed. In Patent Literature 9, an optical film is described, which is obtained by stretching after the residual hydroxyl groups of cellulose ester, specifically cellulose acetate propionate, form a cross-linked structure via covalent bonds and reacted with a cross-linking agent having at least one or more aromatic ring in the cross-linked portion, allowing improvement of film physical properties such as elastic modulus, dimensional stability and the like.
Patent Literature 1: JP 3174367
Patent Literature 2: JP 3459779
Patent Literature 3: JP 2818983
Patent Literature 4: JP 2001-194530 A
Patent Literature 5: JP 2004-309617 A
Patent Literature 6: JP 2002-187960 A
Patent Literature 7: JP 2004-176025 A
Patent Literature 8: JP 2002-131539 A
Patent Literature 9: JP 2004-244497 A

### DISCLOSURE OF THE INVENTION

### Problems to be Solved by the Invention

Desired wavelength dispersion characteristics and birefringence differ depending on an intended application. However, to obtain the desired wavelength dispersion characteristics, conventionally a retardation film had to be used, which composed of polymers being totally different in their main chain parts, basic structures of the polymers, from each other. That means, a polymer had to be synthesized from the main chain part thereof for each material having different wavelength dispersion. This had posed a problem that the wavelength dispersion could not be optionally selected because synthesis and molecular weight control of the polymer were very difficult for some polymer structures. Further, birefringence characteristics includes a positive birefringent property and a negative birefringent property, and though an absolute value of birefringence was able to be controlled by adjusting processing conditions, control of positive or negative could not be achieved unless basic structure of the polymer to be used was changed. Further, there was a problem that a retardation film using a so-called cellulose acetate as described in Patent Literature 2 was poor in birefringence characteristics. Accordingly, for example, to obtain a retardation value necessary for a quarter wavelength retardation film, thickness had to be increased, resulting in fail to sufficiently correspond to the request of thinning. Still further, change of retardation value when a retardation film is tilted from the front direction, so-called visible angle characteristics of a retardation film, was not necessarily superior.

On the other hand, control of visible angle characteristics has been conventionally achieved only by a stretching method. However, in the method in which biaxial stretching was practically performed by laminating a shrinkable film as described in Patent Literature 3, there were additional processes such as lamination of a shrinkable film and delamination after stretching, causing a problem of cost up with these additional processes.

In addition, for improvement of heat resistance of film, it is described in Patent Literature 4 that a retardation film using a polycarbonate resin having a fluorene structure is used, but it had a problem that not only the number of processes increases for laminating but also the thickness as a laminated product is increased because these films must be laminated to a polarizing film with a pressure-sensitive adhesive or the like when used in combination with a polarizing film in spite that they have heat resisting properties.

A retardation film composed of cellulose ester generally had a problem of having lower heat resisting properties compared with one composed of polycarbonate and polyolefin. Therefore, improvements, for example, by adding a compound having two or more aromatic rings to a dope solution were made as shown in Patent Literature 8. However there were problems of coloring and the like because of containing a compound having two or more aromatic rings.

Furthermore, when a cross-linking agent having aromatic rings is used as in Patent Literature 9, there is a problem that coloring occurs on films.

And an optical film composed of cellulose derivatives generally has lower film strength, compared with films strength of an optical film composed of other materials such as cycloolefin polymer or polycarbonate, therefore, further improvement of film strength of an optical film composed of cellulose derivatives is desired.

### Means of Solving the Problems

The inventors of the present invention have made earnest studies to solve the above problems, and found that a retardation film produced from a cellulose derivative having specific properties can solve the above problems to complete the invention. (1) It has been found that by using a retardation film showing nx>ny>nz, or nz≧ny>nx, or ny>nz>nx (nx represents a refractive index in stretching direction, ny represents an refractive index in direction orthogonal to it in plane, and nz represents a refractive index in thickness direction) prepared by uniaxially stretching a film composed of cellulose derivatives in which a hydroxyl group of cellulose is substituted by an acyl group having 5 to 20 carbon atoms, the problems about wavelength dispersion characteristics can be solved, visible angle characteristics and the like. That is, it has been found that wavelength dispersion characteristics and positive or negative of birefringence properties can be optionally controlled by changing the structure and degree of substitution of a substituent of said cellulose, the thickness can be decreased because a film having high birefringence properties can be obtained by selecting said cellulose derivative, and further a retardation film with biaxial characteristics only by uniaxially stretching without practically biaxially stretching described in Patent Literature 3 and with visible angle characteristics controlled, can be obtained by selecting said cellulose derivative. (2) It has been found that heat resisting properties of a film can be improved by a retardation film produced by stretching a cellulose derivative in which a hydroxyl group was substituted by an aliphatic acyl group having 8 to 20 carbon atoms at a degree of substitution of a hydroxyl group of no less than 1.0 and under 2.9 per one cellulose monomer unit. That is, it has been found that a retardation film can be obtained, which exhibits the biaxially characteristics and visible angle characteristics controlled only by uniaxially stretching without practically biaxially stretching as described in Patent Literature 3 by optimizing a degree of substitution of substituent of said cellulose, can be laminated directly with a polarizing element as a support of a polarizing film by alkali treatment of the surface layer, and also has heat resisting properties which can keep the shape of a film even at no lower than 110° C. and negative refractive index anisotropy. (3) It has been found that tearing strength can be improved by a retardation film produced by stretching a cellulose derivative cross-linked with a compound having at least one or more function groups reactable to a residual hydroxyl group of cellulose ester in which a hydroxyl group is substituted by an aliphatic acyl group having 7 to 20, preferably 8 to 20 carbon atoms at a degree of substitution of no less than 1.0 and under 2.9 per one cellulose monomer unit and having a cross-linkable functional group. That is, it has been found that a film having excellent optical characteristics, improved tearing strength, a negative birefringent property and high transparency can be obtained.

That is, the present invention relates to:

(1) A retardation film showing nx>ny>nz, nz≧ny>nx, or ny>nz>nx (nx represents a refractive index in stretching direction, ny represents an refractive index in direction orthogonal to it in plane, and nz represents a refractive index in thickness direction) and being prepared by uniaxially stretching a film composed of a cellulose derivative where a hydroxyl group of cellulose is substituted by an acyl group having 5 to 20 carbon atoms,

(2) The retardation film according to the above aspect (1), which is prepared by uniaxially stretching a film composed of a cellulose derivative having a degree of substitution of 2.0 to 2.8 at which a hydroxyl group of cellulose is substituted by an n-pentanoyl group, and shows nx>ny>nz (nx represents a refractive index in stretching direction, ny represents an refractive index in direction orthogonal to it in plane, and nz represents a refractive index in thickness direction) and an achromatic property in wavelength dispersion characteristics,

(3) The retardation film according to the above aspect (1), which is prepared by uniaxially stretching a film composed of a cellulose derivative having a degree of substitution of 2.0 to 2.5 at which a hydroxyl group of cellulose is substituted by an n-hexanoyl group, and shows nx>ny>nz (nx represents a refractive index in stretching direction, ny represents an refractive index in direction orthogonal to it in plane, and nz represents a refractive index in thickness direction) and an achromatic property in wavelength dispersion characteristics,

(4) The retardation film according to the above aspect (1), which is prepared by uniaxially stretching a film composed of a cellulose derivative where a hydroxyl group of cellulose is substituted by a linear acyl group having 7 to 20 carbon atoms, and characterized by nz≧ny>nx or ny>nz>nx (nx represents a refractive index in stretching direction, ny represents an refractive index in direction orthogonal to it in plane, and nz represents a refractive index in thickness direction) and wavelength dispersion characteristics that a retardation value on the wavelength side longer than 550 nm is smaller than a retardation value at 550 nm and a retardation value on the wavelength side shorter than 550 nm is larger than a retardation value at a wavelength of 550 nm,

(5) The retardation film according to the above aspect (4), wherein a degree of substitution of a linear acyl group having 7 carbon atoms is 2.7 to 3.0,

(6) The retardation film according to the above aspect (4), wherein the degree of substitution of a linear acyl group having 8 to 20 carbon atoms is 2.0 to 3.0,

(7) A retardation film showing ny>nz>nx or nz≧ny>nx (nx represents a refractive index in stretching direction, ny represents an refractive index in direction orthogonal to it in plane, and nz represents a refractive index in thickness direction) and being prepared by uniaxially stretching a film composed of a cellulose derivative where the aliphatic acyl group according to one of the above aspects (1) to (6) and an substituent different from said acyl group are comprised, the degree of substitution of an aliphatic acyl group having 5 to 20 carbon atoms is not less than 2.00 and the sum with the number of other substituents is 2.50 to 3.0 per one cellulose monomer unit,

(8) The retardation film according to the above aspect (1) prepared by stretching a cellulose derivative where the degree of substitution of a hydroxyl group substituted by an aliphatic acyl group having 8 to 20 carbon atoms is not less than 1.0 and under 2.9 per one cellulose monomer unit, wherein a three dimensional refractive index at a measured wavelength of 590 nm satisfies the following Formula (1)

ny>nx Formula (1)

(wherein, nx represents a refractive index in stretching direction in plane of the retardation film and ny represents an refractive index in direction orthogonal to it in plane of the retardation film) and heat resistance is not less than 110° C. (hereinafter, optionally also referred to as heat resistance cellulose derivative),

(9) The retardation film according to the above aspect (8) prepared by stretching a cellulose derivative cross-linked with a compound having at least one or more functional groups reactable to a residual hydroxyl group of a cellulose derivative and a cross-linkable functional group,

(10) The retardation film according to any one of the above aspects (8) or (9), wherein a ratio of retardation values of said retardation film determined at a measured wavelength of 590 nm satisfies the following

Formula (2)

0.5≦R(50)/R(0)≦1.1 Formula (2)

(wherein, R (50) represents a retardation value when the retardation film is observed from a direction tilted by 50 degrees from the front toward the fast axis direction and R (0) represents the retardation value when a retardation film is observed from the front),

(11) A composite retardation film prepared by laminating the retardation film according to any one of the above aspects (1) to (10) and another retardation film,

(12) A circularly or elliptically polarizing film or a rotary polarizing film prepared by laminating the retardation film or the composite retardation film according to any one of the above aspects (1) to (10) and a polarizing film,

(13) An optical film prepared by laminating so that the slow axis of the retardation film according to any one of the above aspects (1) to (10) and the absorption axis or the penetration axis of a polarizing film are parallel or orthogonal to each other,

(14) A composite optical film prepared by laminating a film where ne−no<0 (wherein no represents an average refractive index in a film plate and ne represents a refractive index in thickness direction), Rth calculated from Rth=(no−ne)×d (wherein d represents a thickness) is 100 to 300 nm, and the retardation value in the front direction at 550 nm is 0 to 50 nm, the retardation film according to any one of the above aspects (1) to (10), and a polarizing film in this order so that the slow axis of the retardation film and the absorption axis of a polarizing element are orthogonal to each other,

(15) The circularly or elliptically polarizing film, the rotary polarizing film, the optical film or the composite optical film according to any one of the above aspects (11) to (14), wherein a polarizing element comprising a polarizing film and the retardation film according to any one of the above aspects (1) to (10) are directly laminated,

(16) A image display device prepared with the circularly or elliptically polarizing film, the rotary polarizing film, the optical film or the composite optical film according to any one of the above aspects (11) to (14),

(17) The image display device according to the above aspect (16), wherein the image display device is an liquid crystal display device,

(18) A retardation film prepared by stretching a cellulose derivative cross-linked with an aliphatic compound having at least one or more functional groups reactable to a residual hydroxyl group of cellulose ester in which the degree of substitution of a hydroxyl group substituted by an aliphatic acyl group having 7 to 20 carbon atoms is not less than 1.0 and under 2.9 per one cellulose monomer unit and a cross-linkable functional group (hereinafter, optionally also referred to as cross-linked cellulose derivative), wherein a three dimensional refractive index at a measured wavelength of 590 nm satisfies the following Formula (1),

ny>nx Formula (1)

(wherein, nx represents a refractive index in stretching direction in plane of the retardation film and ny represents an refractive index in direction orthogonal to the stretching direction in plane of the retardation film),

(19) The retardation film according to the above aspect (18), wherein a ratio of retardation values of said retardation film determined at a measured wavelength of 590 nm satisfies the following Formula (2)

0.5≦R(50)/R(0)≦1.1 Formula (2)

(wherein, R (50) represents a retardation value when the retardation film is observed from a direction tilted by 50 degrees from the front toward the fast axis direction and R (0) represents a retardation value when the retardation film is observed from the front),

(20) The retardation film according to the above aspect (18), wherein a tearing strength is not less than 400 kg/cm²,

(21) A composite retardation film prepared by laminating the retardation film according to the above aspect (18) and another retardation film,

(22) An optical film prepared by laminating a polarizing film to the retardation film according to the above aspect (18) or to a composite retardation film prepared by laminating said retardation film and another retardation film,

(23) A liquid crystal display device prepared with the retardation film, the composite retardation film or the optical film according to any one of the above aspects (18) to (22),

(24) The retardation film according to the above aspect (18), wherein the cellulose derivative cross-linked with an aliphatic compound having a cross-linkable functional group is a cellulose derivative cross-linked by polymerization of a (meth)acryloyl group of a compound obtained by reacting an isocyanate group of an aliphatic compound having an isocyanate group and a (meth)acryloyl group to a residual hydroxyl group of cellulose ester,

(25) The retardation film according to the above aspect (24), wherein the aliphatic compound having an isocyanate group and a (meth)acryloyl group is (meth)acryloyloxy (C1 to C20) aliphatic hydrocarbon isocyanate,

(26) Cellulose ester obtained by reacting (meth)acryloyloxy (C1 to C10) aliphatic hydrocarbon isocyanate to cellulose ester in which a degree of substitution of hydroxyl group substituted by an aliphatic acyl group having 7 to 20 carbon atoms is not less than 1.0 to under 2.9 per one cellulose monomer unit.

### Effect of the Invention

By producing a retardation film using a cellulose derivative of the present invention and a resin composition containing the same, wavelength dispersion, positive or negative of birefringence and visible angle characteristics can be controlled. In addition, the transparency is excellent and the heat resistance and tearing strength can be improved. And the thickness can be reduced by using a cellulose derivative having sufficient birefringence. Furthermore, a retardation film of the present invention can be used for a viewing angle compensation film of transmission type liquid crystal display devices, a quarter wavelength retardation film comprising reflection type and semi-transmission type liquid crystal display devices, an anti-reflection film like an anti-reflection film of mirror surface on a touch panel, a visual compensation film like a compensation film to be used for VA (vertical alignment: vertical orientation) or IPS (in-plane switching) mode liquid crystal display devices, a film to improve light utilization efficiency like a wavelength plate for a polarized beam splitter of liquid crystal projectors and a retardation simultaneous compensation film with 1 wavelength or 2 or more wavelengths like a wavelength plate used for a pick-up for writing on an optical disk. A retardation film of the present invention can be used as a circularly polarizing film, a rotary polarizing film, an elliptically polarizing film, an optical film and a composite optical film in combination with a polarizing film for organic electroluminescence type display devices, liquid crystal projectors, liquid crystal display devices and the like, and thus obtained image display devices of the present invention can impart excellent characteristics such as improved contrast and visible angle characteristics compared with conventional image display devices.

### BRIEF DESCRIPTION OF THE DRAWINGS

FIG. 1 shows a graph illustrating wavelength dispersion characteristics of the retardation films of the present invention prepared in Example 1, 2, 4, 6, 7 and Comparative Example 7.

FIG. 2 shows a graph illustrating visible angle characteristics of the retardation films used in Example 12 to 14 and 18.

FIG. 3 shows an example of a composite optical film in accordance with certain embodiments.
3-1 is side view of the composite optical film.
3-2 is exploded view of the composite optical film.

FIG. 4 shows an example of an optical film recited in accordance with certain embodiments.
4-1 is side view of the optical film.
4-2 and 4-3 are exploded view of the optical film.

FIG. 5 shows an example of a circularly or an elliptically polarizing film or a rotary polarizing film in accordance with certain embodiments.

FIG. 6 shows an example of a polarizing element and a retardation film directly laminated in accordance with certain embodiments.

FIG. 7 shows examples of an image display device in accordance with certain embodiments.
7-1 and 7-2 are side views of the Examples.

FIG. 8 shows examples of an image display device recited in accordance with certain embodiments.

### EXPLANATION OF SYMBOLS

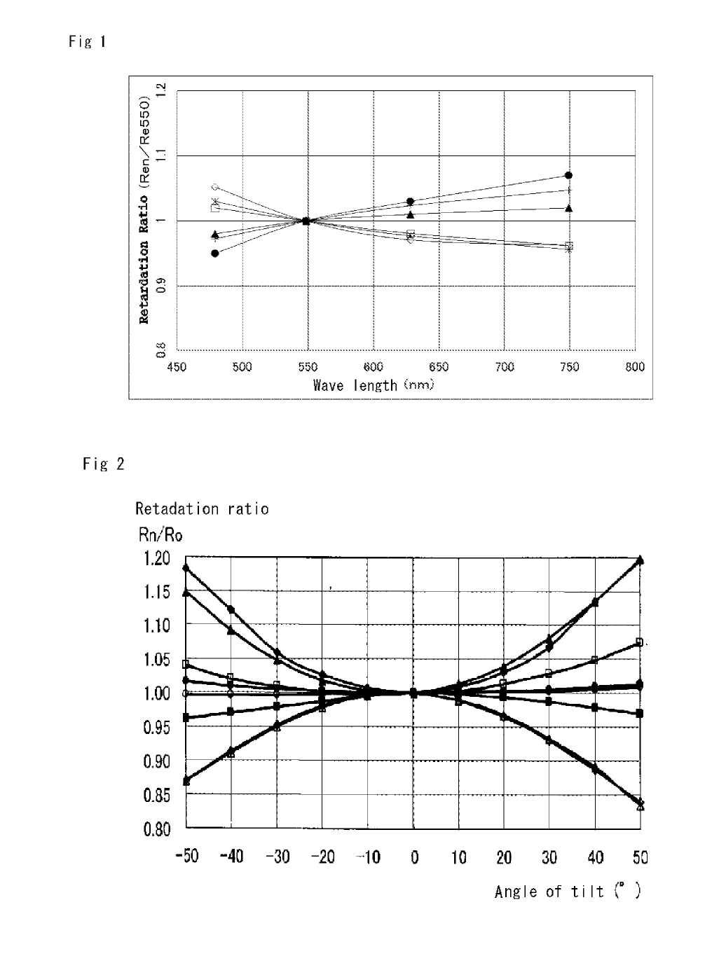

FIG. 1
▴ shows a wavelength dispersion curve of the retardation film prepared in Example 1;
shows a wavelength dispersion curve of the retardation film prepared in Example 2;
□ shows a wavelength dispersion curve of the retardation film prepared in Example 4;
⋄ shows a wavelength dispersion curve of the retardation film prepared in Example 6.
* shows a wavelength dispersion curve of the retardation film prepared in Example 7;
+ shows a wavelength dispersion curve of the retardation film prepared in Comparative Example 7.

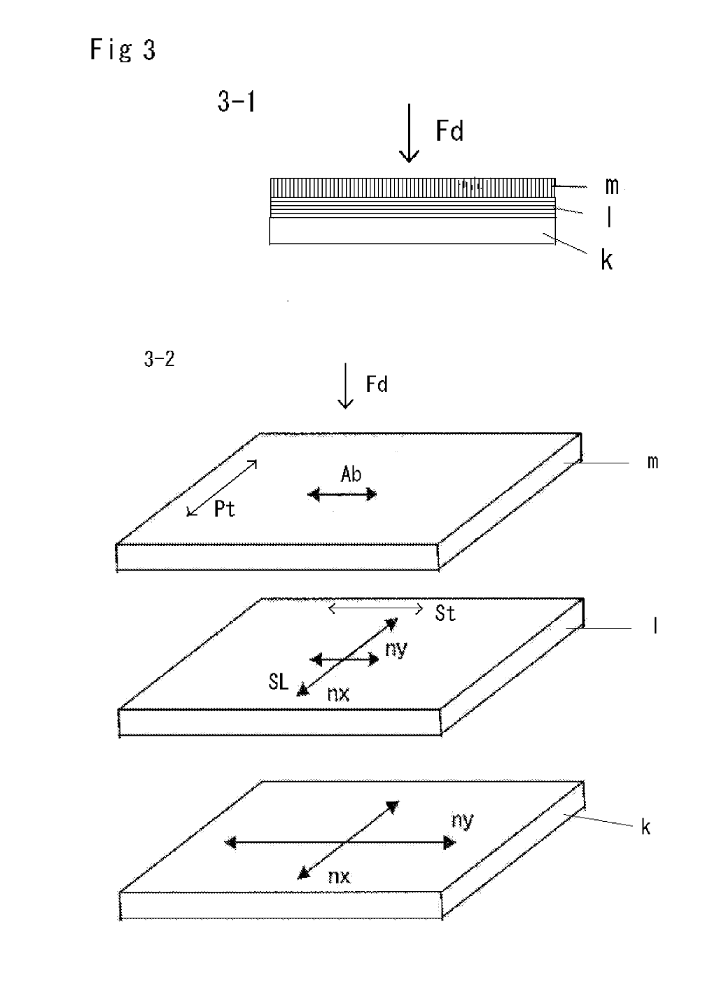

FIG. 2
▴ shows the case when the retardation film in Example 12 is tilted toward the slow axis direction;
Δ shows the case when the retardation film in Example 12 is tilted toward the fast axis direction;
▪ shows the case when the retardation film in Example 13 is tilted toward the slow axis direction;
□ shows the case when the retardation film in Example 13 is tilted toward the fast axis direction;
shows the case when the retardation film in Example 14 is tilted toward the slow axis direction;
∘ shows the case when the retardation film in Example 14 is tilted toward the fast axis direction;
♦ shows the case when the retardation film in Example 18 is tilted toward the slow axis direction;
⋄ shows the case when the retardation film in Example 18 is tilted toward the fast axis direction;

FIG. 3
Ab: Absorption axis
m: Polarizing film
l: Retardation film
k: A film where ne−no<0 (wherein no represents an average refractive index in a film plate, ne represents a refractive index in thickness direction), Rth calculated from Rth=(no−ne)×d (wherein d represents a thickness) is 100 to 300 nm
Pt: Penetration axis
SL: Slaw sxis
St: Stretching direction
nx: Refractive index of uniaxially stretching direction
ny: Refractive index that is at right angles to uniaxially stretching direction in film plane
Fd: Front direction
nx: Refractive index of uniaxially stretching direction
ny: Refractive index that is at right angles to uniaxially stretching direction in film plane

FIG. 4
Ab: Absorption axis
m: Polarizing film
l: retardation film
Pt: Penetration axis
SL: Slaw sxis
St: Stretching direction
nx: Refractive index of uniaxially stretching direction
ny: Refractive index that is at right angles to uniaxially stretching directoin in film plane

If nx is bigger than ny, the slow axis is uniaxially stretching direction. If ny is bigger than nx, the slow axis is at right angles to uniaxially stretching direction

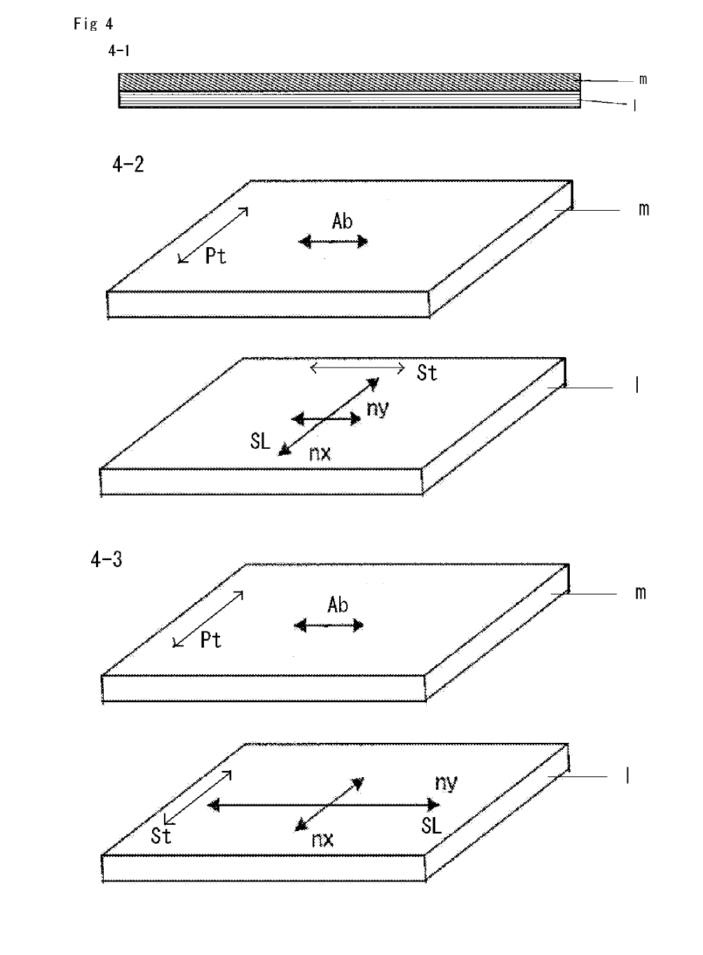

FIG. 5
a: A circularly or elliptically polarizing film or a rotary polarizing film
b: The retardation film or the composite retardation film

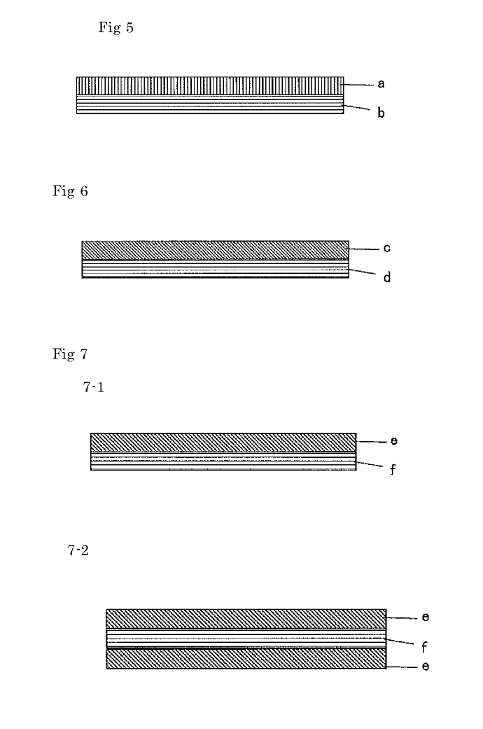

FIG. 6
c: A polarizing element
d: The retardation film

FIG. 7
e: A circularly or elliptically polarizing film or a rotary polarizing film, the optical film or the composite optical film
f: A Luminescence part of imaging device

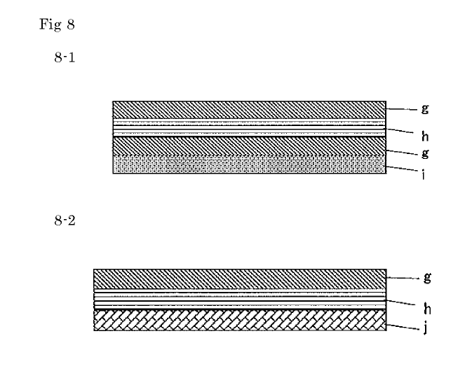

FIG. 8
g: A circularly of elliptically polarizing film or a rotary polarizing film
h: Liquid crystal cell
i: Backlight
j: Reflector

### BEST MODE FOR CARRYING OUT THE INVENTION

Hereinafter, the present invention will be explained specifically.

The type of cellulose that can be used as a starting material in the present invention is, regardless of crystal form and polymerization degree, one having a structure in which a monomer unit represented by Formula (3)

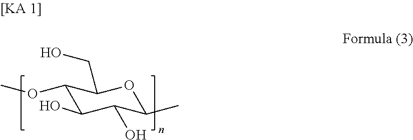

is connected each other, that is, a structure in which D-glucopyranose is connected each other by β-1,4 bonding. In the above formula, n represents the number of connection of the unit, and is generally not less than 10, preferably not less than 50 and more preferably not less than 100, and the upper limit is not particularly limited but generally not more than 10,000, preferably not more than 5,000 and more preferably not more than 2,000. Specifically, the type of cellulose includes natural cellulose, powdered cellulose, crystal cellulose, regenerated cellulose, cellulose hydrate, rayon or the like. When homogeneity in quality and the like are required, it is preferable to use those having an artificially adjusted number of connections (number of polymerization). In such a case, preferably n is approximately 100 to 1,000, and optionally approximately 150 to 600.

The cellulose derivative to be used for preparing the retardation film of the present invention in which the three dimensional refractive indexes prepared by uniaxially stretching the film show nx>ny>nz, nz≧ny>nx or ny>nz>nx (nx represents a refractive index in stretching direction, ny represents an refractive index in direction orthogonal to it in plane, and nz represents a refractive index in thickness direction) is one in which a hydroxyl group of the cellulose is substituted by a (C5 to C20) aliphatic acyl group, and can be represented by the following Formula (4)

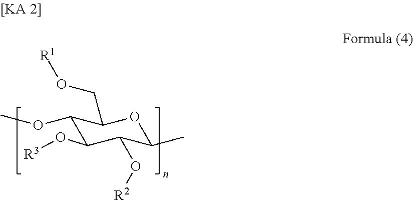

In the above Formula (4), n is same to the above, and R¹, R² and R³ are hydrogen atoms or substituents. R¹, R² and R³ may be same or different from each other, but R¹, R² and R³ are not all hydrogen atoms at the same time, and at least one of R¹, R² and R³ is a (C5 to C20), more preferably (C5 to C16) and further preferably (C5 to C12) linear aliphatic acyl group, and the rest group(s) may be substituted by other substituents.

In the cellulose derivative substituted by the above (C5 to C20) aliphatic acyl group(s), the number of the substituent per one cellulose monomer unit (hereinafter, referred to as degree of substitution) differs depending on the number of carbon atom of a linear acyl group to be used. For example, in the case of cellulose n-pentanate, by having a degree of substitution of preferably 2.0 to 3.0, more preferably 2.0 to 2.8, a retardation film of the present invention obtained by uniaxially stretching said film composed of cellulose n-pentanate can show nx>ny>nz (nx represents a refractive index in stretching direction, ny represents an refractive index in direction orthogonal to it in plane, and nz represents a refractive index in thickness direction) and impart wavelength dispersion characteristics having so-called achromatic property that the retardation value on the longer wavelength side is larger than the retardation value at a wavelength of 550 nm and the retardation value on the shorter wavelength side is smaller than the retardation value at a wavelength of 550 nm. And in the case of using cellulose n-hexanate, a retardation film of the present invention prepared by uniaxially stretching the film composed of cellulose n-hexanate can show, by having a degree of substitution of preferably 2.0 to 2.9, more preferably 2.0 to 2.8, further preferably 2.0 to 2.5, nx>ny>nz (nx represents a refractive index in stretching direction, ny represents an refractive index in direction orthogonal to it in plane, and nz represents a refractive index in thickness direction) and impart wavelength dispersion characteristics having so-called achromatic property that the retardation value on a longer wavelength side is larger than the retardation value at a wavelength of 550 nm and the retardation value on a shorter wavelength side is smaller than the retardation value at a wavelength of 550 nm. Similarly, nx>ny>nz is shown and wavelength dispersion characteristics having so-called achromatic property that the retardation value on a longer wavelength side is larger than the retardation value at a wavelength of 550 nm and the retardation value on a shorter wavelength side is smaller than the retardation value at a wavelength of 550 nm are imparted. In the case of cellulose n-heptanate, by having a degree of substitution of 1.5 to 2.3, similarly, nx>ny>nz is shown and wavelength dispersion characteristics that the retardation value on the longer wavelength side is smaller than the retardation value at a wavelength of 550 nm and the retardation value on the shorter wavelength side is larger than the retardation value at a wavelength of 550 nm are prepared.

In addition, when the degree of substitution of cellulose n-heptanate is 2.5 to 3.0, more preferably 2.7 to 3.0, by usually uniaxially stretching, a retardation film of the present invention can be obtained, which has biaxial characteristics of two direction orientation, stretching direction in a film plate (or a direction orthogonal to it in a film plate) and thickness direction (hereinafter, also referred to as exhibition of biaxial characteristics), and wavelength dispersion characteristics where the retardation value on the wavelength side longer than 550 nm is smaller than the retardation value at a wavelength of 550 nm and the retardation value on the wavelength side shorter than 550 nm is larger than the retardation value at a wavelength of 550 nm. The biaxial characteristics are, in the case of the present invention, characterized by ny>nz>nx or nz≧ny>nx when a refractive index of stretching direction is nx, a refractive index of direction orthogonal to it in plate is ny, and a refractive index of thickness direction is nz. Furthermore, in the case of cellulose derivative substituted by a linear acyl group having 8 to 20 carbon atoms such as cellulose n-octanate, cellulose n-nonanate, cellulose n-decanate, cellulose n-undecanate, cellulose n-dodecanate, cellulose n-tridecanate, cellulose n-tetradecanate, cellulose n-pentadecanate, cellulose n-hexadecanate, cellulose n-heptadecanate, cellulose n-octadecanate, cellulose n-nanodecanate, and cellulose n-eicosanate, more preferably cellulose derivative substituted by a linear acyl group having 8 to 16 carbon atoms such as cellulose n-octanate, cellulose n-nonanate, cellulose n-decanate, cellulose n-undecanate, cellulose n-dodecanate, cellulose n-tridecanate, cellulose n-tetradecanate, cellulose n-pentadecanate, and cellulose n-hexadecanate, not only biaxial characteristics exhibit but also the wavelength dispersion has a characteristic that the retardation value on the wavelength side longer than 550 nm is smaller than the retardation value at a wavelength of 550 nm and the retardation value on the wavelength side shorter than 550 nm is larger than the retardation value at a wavelength of 550 nm when the degree of substitution is, for example, 1.0 to 3.0, preferably 2.5 to 3.0, more preferably 2.5 to 3.0.

These biaxial characteristics are, in the case of the present invention, characterized by ny>nz>nx and nz≧ny>nx when a refractive index of stretching direction is nx, a refractive index of direction orthogonal to it in plate is ny, and a refractive index of thickness direction is nz. When an aliphatic substituent having 5 to 20 carbon atoms and a substituent different from said aliphatic substituent, the substituent number of aliphatic acyl group having 5 to 20 carbon atoms is not less than 2.0 and the sum with the number of other substituent is 2.5 to 3.0 per one cellulose monomer unit, more preferably 2.7 to 3.0.

A preferable example of another substituent other than the (C5 to C20) aliphatic acyl group in the formula (4) is a carbamoyl group or an acyl group other than the (C5 to C20) aliphatic acyl group. Specifically the substituents include a group represented by Y—CO— group or Z—NH—CO— group. Here, Y is not particularly limited as long as it is a group other than a non-substituted (C5 to C20) aliphatic group, and specifically includes a substituted or a non-substituted (C1 to C20) hydrocarbon residue excluding a non-substituted (C5 to C20) aliphatic group. A substituent of said hydrocarbon residue is not particularly limited, and includes a hydroxyl group, a halogen atom, an amino group, a cyano group, a (C1 to C14) acyloxy group, a (C1 to C14) alkyloxy group, a phenyl group, a naphthyl group and the like. When said hydrocarbon residue is an aromatic group, the substituent further includes a (C1 to C10) alkyl group.

Said hydrocarbon residue includes, for example, a vinyl group, a methyl group, an ethyl group, a propyl group, an isopropyl group, an n-butyl group, an iso-butyl group, a tert-butyl group, a benzyl group, a 1-naphthylmethyl group, a trifluoromethyl group, an aminomethyl group, a 2-amino-ethyl group, a 3-amino-n-propyl group, a 4-amino-n-butyl group, or a group in which an amino group thereof is further converted to amide or urethane, a hydroxy-substituted (C1 to C4) alkyl group, or a group in which a hydroxyl group thereof is further substituted by a (C1 to C14) acyl group or a (C1 to C14) alkyl group, a vinyl group which may be substituted by a (C1 to C3) alkyl group, a cyanobiphenyloxy (C3 to C10) alkyl group, a phenylacetylenylphenyl (C1-C20) alkyl group, an aliphatic group with a unsaturated bond having 1 to 10 carbon atoms such as an acetylene group and a cinnamoyl group, and an acyl group with an aromatic group such as a phenyl group, a naphthyl group, an anthracenyl group, a fluorenyl group, a biphenyl group and a 4-trifluoromethylphenyl group. Z includes a (C1 to C10) aliphatic group which may have a substituent, and specifically, for example, a (meth)acryloyloxyethyl group, a vinyl group, a methyl group, an ethyl group, a propyl group, an isopropyl group, an n-butyl group, an iso-butyl group, a tert-butyl group, a pentyl group, a neopentyl group, a hexyl group, a cyclohexyl group, an octyl group, a nonyl group, a decyl group, a benzyl group, a 1-naphtylmethyl group and a trifluoromethyl group.

From these (C5-C20) aliphatic acyl groups and optionally other substituent, one or more substituents are properly selected according to desired birefringence characteristics, wavelength dispersion characteristics, viscosity, orientating ability, processability, reactivity and the like of an intended cellulose derivative of the present invention. Further, the degree of substitution of a hydroxyl group of the cellulose is also properly selected according to desired birefringence characteristics, wavelength dispersion characteristics, viscosity, orientating ability, processability, reactivity and the like of an intended cellulose derivative of the present invention.

By introducing a polymerizable group into the cellulose derivative, a retardation film superior in mechanical strength, reliability and solvent resistance can be obtained by polymerization by irradiating UV rays, in the presence of a photopolymerization initiator if necessary, after orientation treatment, to fix the oriented state. The polymerizable group includes, for example, a group in which the above Y or Z is a vinyl group, that is, an acryloyl group and a methacryloyl group. As the photoinitiator, a compound used for usual ultraviolet-curable resins can be used.

Specific examples of said photopolymerization initiator include, acetophenone type compounds such as 2-methyl-1-[4-(methylthio)phenyl]-2-morpholinopropane-1,1-hydroxycyclohexylphenylketone, 4-(2-hydroxyethoxy)-phenyl(2-hydroxy-2-propyl)ketone, 1-(4-dodecylphenyl)-2-hydroxy-2-methylpropane-1-one, 1-(4-isopropylphenyl)-2-hydroxy-2-methylpropane-1-one, 2-hydroxy-2-methyl-1-phenylpropane-1-one, and diethoxyacetophenone; benzoin type compounds such as benzoin, benzoin methyl ether, benzoin ethyl ether, benzoin isopropyl ether, benzoin isobutyl ether and 2,2-dimethoxy-2-phenylacetophenone; benzophenone type compounds such as benzoylbenzoic acid, methyl benzoylbenzoate, 4-phenylbenzophenone, hydroxybenzophenone, 4-benzoyl-4′-methyldiphenyl sulfide and 3,3′-dimethyl-4-methoxybenzophenone; and thioxanthone type compounds such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone and 2,4-diisopropylthioxanthone. These photopolymerization initiators may be used alone or in combination of two or more kinds thereof at an each optional ratio.

In the case that benzophenone type compounds or thioxanthone type compounds are used, an adjuvant may be also used to promote photopolymerization reaction. Examples of such an adjuvant include, for example, amine type compounds such as triethanolamine, methyldiethanolamine, triisopropanolamine, n-butylamine, n-methyldiethanolamine, dimethylaminoethylmethacrylate, Michler's ketone, 4,4′-diethylaminophenone, ethyl 4-dimethylaminobenzoate, (n-butoxy)ethyl 4-dimethylaminobenzoate and isoamyl 4-dimethylaminobenzoate. The content of the above photoinitiator is preferably not less than 0.5 parts by weight and not more than 10 parts by weight and more preferably approximately no less than 2 parts by weight and no more than 8 parts by weight based on 100 parts by weight of the (meth)acrylate compound (when an acryloyl group is present in the polymer, it is included). Also, the content of the adjuvant is preferably approximately 0.5 equivalents to 2 equivalents to the photoinitiator.

The quantity of radiation of ultraviolet rays is preferably about 100 to 1000 mJ/cm², though it varies depending on the type of said liquid crystal mixed-composition, the type and amount of the photoinitiator to be added and the film thickness. Irradiation of ultraviolet rays can be carried out in an atmosphere of air or inert gas such as nitrogen. However, if the film is thinner, curing is not performed sufficiently due to oxygen hindrance. In such a case, it is preferable to irradiate with ultraviolet rays in an inert gas atmosphere.

In addition to the above photoinitiator, a reactive monomer different from the cellulose derivative can be added to the cellulose derivative to produce a retardation film of the present invention. The reactive monomer is preferably a polymerizable compound by heat or light and a polymerizable compound by light such as ultraviolet rays. Such compounds include, for example, (meth)acrylate compounds.

The (meth)acrylate compounds to be used include, for example, trimethylolpropanetri(meth)acrylate, pentaerythritoltri(meth)acrylate, pentaerythritoltetra(meth)acrylate, ditrimethylolpropanetetra(meth)acrylate, dipentaerythritolpentaacrylate, dipentaerythritolhexaacrylate, reaction products of pentaerythritoltri(meth)acrylate and 1,6-hexamethylenediisocyanate, reaction products of pentaerythritoltri(meth)acrylate and isophoronediisocyanate, tris(acryloxyethyl)isocyanurate, tris(methacryloxyethyl)isocyanurate, reaction products of glyceroltriglycidyl ether and (meth)acrylic acids, caprolactone-modified tris(acryloxyethyl)isocyanurate, reaction products of trimethylolpropanetriglycidyl ether and (meth)acrylic acids, triglyceroldi(meth)acrylate, reaction products of propylene glycol diglycidyl ether and (meth)acrylic acids, polypropylene glycol di(meth)acrylate, tripropylene glycol di(meth)acrylate, polyethylene glycol di(meth)acrylate, tetraethylene glycol di(meth)acrylate, triethylene glycol di(meth)acrylate, pentaerythritol di(meth)acrylate, reaction products of 1,6-hexanediol diglycidyl ether and (meth)acrylic acids, 1,6-hexanedioldi(meth)acrylate, glycerol di(meth)acrylate, reaction products of ethylene glycol diglycidyl ether and (meth)acrylic acids, reaction products of diethylene glycol diglycidyl ether and (meth)acrylic acids, bis(acryloxyethyl)hydroxyethylisocyanurate, bis(methacryloxyethyl)hydroxyethylisocyanurate, reaction products of bisphenol A diglycidyl ether and (meth)acrylic acids, tetrahydrofurfuryl(meth)acrylate, caprolactone-modified tetrahydrofurfuryl(meth)acrylate, 2-hydroxyethyl(meth)acrylate, 2-hydroxypropyl(meth)acrylate, polypropylene glycol (meth)acrylate, polyethylene glycol (meth)acrylate, phenoxyhydroxypropyl(meth)acrylate, acryloylmorpholine, methoxypolyethylene glycol (meth)acrylate, methoxytetraethylene glycol (meth)acrylate, methoxytriethylene glycol (meth)acrylate, methoxyethylene glycol (meth)acrylate, methoxyethyl(meth)acrylate, glycidyl(meth)acrylate, glycerol(meth)acrylate, ethylcarbitol(meth)acrylate, 2-ethoxyethyl(meth)acrylate, N,N-dimethylaminoethyl(meth)acrylate, 2-cyanoethyl(meth)acrylate, reaction products of butyl glycidyl ether and (meth)acrylic acids, butoxytriethylene glycol (meth)acrylate, butanediolmono(meth)acrylate and the like. These compounds may be used either alone or in mixture of two or more kinds thereof. A desired orientation state can be fixed by using such a reactive compound and polymerizing under appropriate conditions.

In addition, the residual hydroxyl groups of the above cellulose derivative can be cross-linked by a cross-linking agent. As the cross-linking agent, isocyanates such as Colonate HL (manufactured by Nippon Polyurethane Industrial Ltd.), L-45 (manufactured by Soken Chemical & Engineering Co., Ltd.) and Dulanate (manufactured by Asahi Chemical Industry Co., Ltd.), SUMIJULE (manufactured by SUMITOMO BYER URETHANE Co., Ltd.) are preferably used. Furthermore, in order to promote cross-linking reaction, a catalyst such as dibutyltin dilaurate may be added. These cross-linking reactions are preferably carried out in any one of such processes as film making process, stretching process or after-stretching process to produce a retardation film of the present invention film. Specifically, the cross-linking reaction is achieved, under the presence of the above cross-linking agent and a catalyst, upon heating in the drying process of the making process, upon heating during stretching in the stretching process, or by heat treatment of an obtained retardation film after stretching. For example, in the case that Dulanate (manufactured by Asahi Chemical Industry Co., Ltd.) is used as a cross-linking agent for a method to cross-link residual hydroxyl groups of a cellulose derivative of the present invention by a cross-linking agent, the quantity of a cross-linking agent to be used is 0.1% by weight to 50% by weight, preferably 0.5% by weight to 30% by weight, more preferably 1% by weight to 15% by weight based on the cellulose derivative. And the drying temperature in film making is in the range of 20° C. to 160° C., particularly preferably 70° C. to 130° C.

With regard to cellulose derivative to be used for producing a retardation film of the present invention characterized by that three dimension refractive index at a measured wavelength of 590 nm satisfies ny>nx (nx represents a refractive index in stretching direction, and ny represents an refractive index in direction orthogonal to the stretching direction in plane of a retardation film) and that the heat resistance is not less than 110° C., each substituent (R1, R2 and R3) in the following Formula (4) is in the following range. That is, at least one of the hydroxyl groups of a cellulose unit is substituted by a (C8 to C20) aliphatic acyl group.

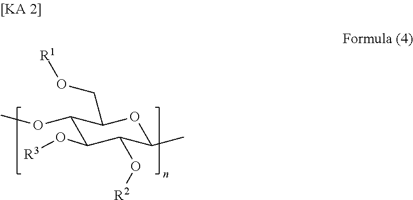

In the above Formula (4), n is same to the above, and R¹, R² and R³ are hydrogen atoms or substituents. R¹, R² and R³ are not all hydrogen atoms and at least one of them is a (C8 to C20), more preferably (C8 to C16), further preferably (C8 to C12) aliphatic acyl group. Particularly, a (C8 to C12) aliphatic acyl group provides good solubility to solvent, easy processability and proper strength to an obtained retardation film.

By adjusting the degree of substitution of a cellulose derivative substituted by the above (C8 to C20) aliphatic acyl group, the heat resistance can be improved. Heat resistance means a temperature at which a film does not melt, and in the case of a retardation film of the present invention, heat resistance is characterized by being not less than 110° C., more preferably not less than 120° C., further preferably not less than 130° C. There is no problem when the number of substituent per one cellulose monomer unit (hereinafter, referred to as a degree of substitution) of cellulose derivative to be used in a retardation film of the present invention is not less than 1.0 to under 2.9, and it is usually not less than 1.5 and under 2.9, more preferably not less than 1.8 and under 2.9. By generally uniaxially stretching using a cellulose derivative having such a degree of substitution, not only the heat resistance is excellent but also a retardation film having biaxial characteristics of two direction orientation being stretching direction in a film plate (or a direction orthogonal to it in a film plate) and thickness direction (hereinafter, also referred to as exhibition of biaxial characteristics) can be obtained. The biaxial characteristics is characterized by ny>nz>nx or nz≧ny>nx when the refractive index of stretching direction is nx, the refractive index of direction orthogonal to it in a plane is ny, and the refractive index of thickness direction is nz. Such biaxial characteristics exhibit when using a cellulose substituted by a acyl group having 8 to 20 carbon atoms such as cellulose n-octanate, cellulose n-nonanate, cellulose n-decanate, cellulose n-undecanate, cellulose n-dodecanate, cellulose n-tridecanate, cellulose n-tetradecanate, cellulose n-pentadecanate, cellulose n-hexadecanate, cellulose n-heptadecanate, cellulose n-octadecanate, cellulose n-nanodecanate and cellulose n-eicosanate, and more preferably cellulose substituted by an acyl group having 8 to 16 carbon atoms such as cellulose n-octanate, cellulose n-nonanate, cellulose n-decanate, cellulose n-undecanate, cellulose n-dodecanate, cellulose n-tridecanate, cellulose n-tetradecanate, cellulose n-pentadecanate and cellulose n-hexadecanate, further preferably cellulose substituted by an acyl group having 8 to 12 carbon atoms such as cellulose n-octanate, cellulose n-nonanate, cellulose n-decanate, cellulose n-undecanate and cellulose n-dodecanate is preferably used. Cellulose substituted by an acyl group having 8 to 12 carbon atoms is particularly preferred because having a degree of substitution of no less than 1.0 and under 2.9, more preferably no less than 1.5 and under 2.9, further preferably no less than 1.9 and under 2.9 can prevent said retardation film from melting even when heated to 160° C. and impart excellent heat resistance and biaxial characteristics.

The degree of biaxial characteristics can be determined by calculating the ratio of a retardation value in the front direction of a retardation film and the retardation values in the case of tilting by a certain degree toward the slow axis direction and the fast axis direction. In the case of a retardation film of the present invention, when the retardation value of the front direction in said retardation film at a wavelength of 590 nm is R (0) and the retardation value in the case of tilting by 50° toward the fast axis direction is R (50), the ratio of R (50)/R (0) being no less than 0.5 and no more than 1.1, more preferably no less than 0.8 and no more than 1.1, further preferably no less than 0.95 and no more than 1.05 can improve the visible angle characteristics because of a smaller difference of the retardation values of the front direction and the retardation value in the case of tilting.

A preferable substituent of these (C8 to C20) aliphatic acyl groups is selected according to birefringence, viscosity, orientating ability, processability, reactivity and the like of an intended cellulose derivative of the present invention. And a degree of substitution of cellulose hydroxyl group is properly determined according to birefringence, viscosity, orientating ability, processability, reactivity and the like of an intended cellulose derivative of the present invention.

In addition, cellulose ester to be used for production of the above cross-linked cellulose derivative is preferably substituted by a (C7 to C20) aliphatic acyl group at a degree of substitution of no less than 1.0 and under 2.9 for the above cellulose derivative to be used for a retardation film of the present invention. Each substituent in the following Formula (4) for such cellulose ester is one in the following range.

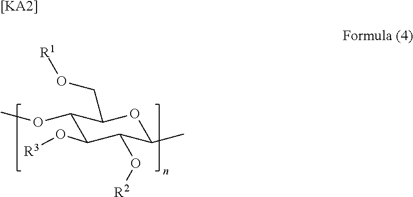

In the above Formula (4), n is same to the above, R¹, R² and R³ are a hydrogen atom or a substituent, R¹, R² and R³ may be same or different but R¹, R² and R³ are not all hydrogen atoms, at least one of them is a (C7 to C20) or (C8 to C20), more preferably (C8 to C16), further preferably (C8 to C12) aliphatic acyl group, and the degree of substitution is not less than 1.0 and under 2.9.

A (C7 to C20) aliphatic acyl group can be represented by X—CO-group, X includes n-hexyl, sec-hexyl, cyclohexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl and the like, and preferably X is n-hexyl, sec-hexyl, cyclohexyl, n-heptyl, n-octyl, n-nonyl, n-decyl, n-undecyl, n-dodecyl and the like. More preferable is a (C8 to C20) aliphatic acyl group, and preferably X among them is n-heptyl, n-octyl, n-nonyl, n-decyl, n-undecyl, n-dodecyl and the like. In addition, a linear (C8 to C20) aliphatic acyl group is one of preferable groups. Among alkyl groups above exemplified as X, one included in a linear alkyl is usually more preferable.

There is no problem when the number of substituent per one cellulose monomer unit (hereinafter, referred to as a degree of substitution) of cellulose ester substituted by the above (C7 to C20) aliphatic acyl group is not less than 1.0 and under 2.9, usually not less than 1.5 and under 2.9, more preferably not less than 1.5 and under 2.8.

The above cross-linked cellulose derivative can be obtained by reaction of the above cellulose ester with an aliphatic compound having at least one functional group reactable to the residual hydroxyl group(s) of said ester and a crosslinkable functional group (hereinafter, also referred to as aliphatic compound for cross-linking), and if required, polymerization reaction. For example, the above cross-linked cellulose derivative can be also obtained by cross-linking the above cellulose ester by an aliphatic compound having two and more functional groups reactable to residual hydroxyl group of the above cellulose ester. As the above aliphatic compound for cross-linking, for example, preferable are aliphatic compounds having a functional group such as a formyl group, an isocyanate group, a thioisocyanate group, a carboxyl group, an acid anhydride group, a sulfonic acid group, an epoxy group, a vinyl group and a halogen atom, or an aliphatic compound having a polymerizable group such as an allyl group, a vinylether group, a vinyl group, a (meth)acryloyl group and an epoxy group, and more preferable are aliphatic compounds having an isocyanate group, a thioisocyanate group, a carboxyl group, an acid anhydride group, a halogenocarbonyl group, a sulfonic acid group, an allyl group, a vinylether group, a vinyl group, a (meth)acryloyl group and an epoxy group. The number of carbon atom of aliphatic residual group except the above functional groups in said aliphatic compound is preferably approximately 1 to 20, more preferably 1 to 15, further preferably approximately 1 to 10. In addition, when the above functional groups are two halogenocarbonyl groups, the number of carbon atoms of the above aliphatic residual group is preferably approximately 5 to 15. There is no problem as long as an aliphatic compound having a polymerizable group (preferably, a (meth)acryloyl group) and an isocyanate group has the above range, however, preferably approximately 1 to 10, more preferably approximately 1 to 5. One of said preferable aliphatic compounds includes an aliphatic compound having two reactivity groups to a hydroxyl group (preferably, a halogenocarbonyl group) or an aliphatic compound containing both of a reactivity group to a hydroxyl group (preferably, an isocyanate group) and a polymerizable group (preferably, a (meth)acryloyl group). More specifically, the latter one can include an aliphatic compound containing an isocyanate group and a (meth)acryloyl group.

These compounds can be used alone or in combination of two or more kinds.

The aliphatic compound having two halogenocarbonyl groups includes, for example, a compound represented by Cl(O)C—X1-C(O)Cl, wherein X1 represents a single bond or a divalent aliphatic residue having 1 to 20 carbon atoms. When X1 is a single bond, said compound is Cl(O)C—C(O)Cl. When X1 is a divalent aliphatic residue having 1 to 20 carbon atoms, said aliphatic residue is preferably a linear one, more preferably a linear alkyl group having 5 to 15 carbon atoms.

The aliphatic compound containing both of a reactivity group to a hydroxyl group and a polymerizable group includes a compound represented by Y1-X2-Y2. X2 represents a divalent aliphatic residue having 1 to 20 carbon atoms. Said aliphatic residue is preferably a linear aliphatic group having 1 to 20 carbon atoms, more preferably a linear alkyl group having 1 to 10 carbon atoms. Y2 is isocyanate group —N═C═O or protected isocyanate group —N—C(O)—B. B is a protecting group of isocyanate and the structure is preferably —ON═C(R1)(R2), wherein each of R1 and R2 is any one of hydrogen, a methyl group, an ethyl group, an n-propyl group, an n-butyl group and an n-pentyl group. Y1 is a polymerizable group, preferably a (meth)acroyloxy group (CH₂═CHC(O)O— or CH₂═C(CH₃)C(O)O—). Specifically, decanedioyl dichloride, 2-methacryloyloxyethylisocyanate, 2-acryloyloxyethylisocyanate, 1,1-bis(acryloyloxymethyl)ethylisocyanate, methacrylic acid 2-(0-[1′methylpropylideneamino]carboxyamino)ethyl and the like are included.

The amount of said aliphatic compound to be added differs depending on the aliphatic compound to be added a degree of substitution of, material cellulose ester and the like, however typically, approximately 0.5 parts to 20 parts, preferably approximately 1 to 15 parts, more preferably approximately 1.5 to 10 parts, further preferably approximately 1.5 to 7 parts, based on 100 parts (by weight) of said material cellulose ester.

As for one of the methods for forming a cross-linked structure with an aliphatic compound having such a crosslinkable functional group, for example, a cross-linked structure can be formed by reaction of material cellulose ester having a plurality of residual hydroxyl groups and a plurality of isocyanate groups when an aliphatic compound having at least two functional groups reactable to hydroxyl groups of cellulose ester, preferably a compound having two or more isocyanate groups is used, as described above. Also, for example, using a compound having said functional group reactable to a hydroxyl group of the above cellulose ester (also referred to as a reactive functional group), preferably an isocyanate group and said polymerizable group, preferably a (meth)acryloyl group, after a reactive functional group, for example, an isocyanate group and a residual hydroxyl group of said cellulose ester are reacted, said polymerizable group, for example, a (meth)acryloyl group is subjected to polymerization reaction to cross-link cellulose ester of the present invention to achieve to form a cross-linked structure.

In order to promote the above cross-linking reaction, if required, heat treatment may be carried out, or a catalyst such as dibutyltin dilaurate, a condensation agent such as N,N′-dicyclohexylcarbodiimide and the like may be used. For example, it is one of the preferable embodiments to react the above isocyanate group and residual hydroxyl group of cellulose ester of the present invention under the presence of a catalyst such as dibutyltin dilaurate. The amount of a catalyst such as dibutyltin dilaurate to be added may be a catalytic amount and, for example, approximately 0.001 part to 0.1 part based on 100 parts (by weight) of material cellulose ester.

In addition, for a cellulose derivative having a photopolymerizable group such as the above allyl group, vinylether group, vinyl group, (meth)acryloyl group and epoxy group, a cross-linked structure can be formed by polymerization reaction by conducting photoirradiation. Usually, UV irradiation is used for photoirradiation. For example, by irradiating ultraviolet rays for polymerization before or after stretching, if required, under the presence of a photopolymerization initiator, a retardation film excellent in mechanical strength and solvent resistance can be obtained. As the photopolymerization initiator, a compound to be used for usual ultraviolet-curable resin can be used.

Specific examples of said photopolymerization initiator include benzoin type compounds such as 2,2-dimethoxy-2-phenylacetophenone, benzophenone type compounds such as 4-phenylbenzophenone and thioxanthone type compounds such as 2,4-diisopropylthioxanxanthone. These photopolymerization initiators can be used alone or in mixture thereof at an optional ratio.

Some types of photopolymerization initiator can be used in combination with an adjuvant in order to promote photopolymerization reaction. Such an adjuvant includes, for example, amine type compounds such as triethanolamine, methyldiethanolamine, triisopropanolamine, n-butylamine, n-methyldiethanolamine and diethylaminoethyl methacrylate.

The quantity of radiation of ultraviolet rays for photoirradiation differs depending on the type of said cellulose derivative, the type and content of a photopolymerizable group and the film thickness, however, the quantity of radiation may be about 100 to 1000 mJ/cm² for each radiation. And, UV irradiation may be carried out in an atmosphere of air or inert gas such as nitrogen. However, if the film is thinner, curing is not performed sufficiently due to oxygen hindrance. In such a case, preferably in an inert gas atmosphere, irradiation of ultraviolet rays is carried out for curing.

Usually, forming into a film shape after curing is difficult, so preferable is forming into a film shape before curing followed by curing.

One preferable method is that firstly, using a compound having a reactive functional group (preferably, an isocyanate group) and the above polymerizable group (preferably, a (meth)acryloyl group) as an aliphatic compound for cross-linking, said compound is reacted to residual hydroxyl group of the above cellulose ester to be cellulose ester having a polymerizable group, and then a solution of said polymerizable cellulose ester is coated on a releasing film and the like, followed by eliminating the solvent to form a film. Subsequently, by polymerization reaction of said polymerizable group, for example, a (meth)acryloyl group, a film composed of cross-linked cellulose derivative can be obtained.

By usually uniaxially stretching with such a film composed of a cross-linked cellulose derivative, a retardation film having not only excellent tearing strength but also no color as well as biaxial characteristics of two direction orientation, the stretching direction in a film plane (or a direction orthogonal to it in a film plane) and the thickness direction (hereinafter, referred to as exhibition of biaxial characteristics), can be obtained. The biaxial characteristics are characterized by ny>nz>nx or nz≧ny>nx wherein nx represents a refractive index in the stretching direction, ny represents an refractive index in the direction orthogonal to it in the plane, and nz represents a refractive index in the thickness direction. Such biaxial characteristics exhibit when using a cellulose ester substituted by an acyl group having 8 to 20 carbon atoms such as cellulose n-octanate, cellulose n-nonanate, cellulose n-decanate, cellulose n-undecanate, cellulose n-dodecanate, cellulose n-tridecanate, cellulose n-tetradecanate, cellulose n-pentadecanate, cellulose n-hexadecanate, cellulose n-heptadecanate, cellulose n-octadecanate, cellulose n-nanodecanate and cellulose n-eicosanate, and more preferably cellulose ester substituted by an acyl group having 8 to 16 carbon atoms such as cellulose n-octanate, cellulose n-nonanate, cellulose n-decanate, cellulose n-undecanate, cellulose n-dodecanate, cellulose n-tridecanate, cellulose n-tetradecanate, cellulose n-pentadecanate and cellulose n-hexadecanate, further preferably cellulose ester substituted by an acyl group having 8 to 12 carbon atoms such as cellulose n-octanate, cellulose n-nonanate, cellulose n-decanate, cellulose n-undecanate and cellulose n-dodecanate. In the case of a cellulose ester substituted by an acyl group having 8 to 12 carbon atoms, a cellulose derivative cross-linked with the above cellulose ester having a degree of substitution of, for example, no less than 1.0 and under 2.9, more preferably no less than 1.5 and under 2.9, further preferably no less than 1.5 and under 2.8, is particularly preferred to improve tearing strength and impart biaxial characteristics.

The degree of biaxial characteristics can be determined by calculating the ratio of the retardation value in the front direction of a retardation film and the retardation value in the case of tiling by a certain degree toward the slow axis direction or the fast axis direction. As for a retardation film of the present invention, when the retardation value in the front direction of said retardation film at a wavelength of 590 nm is R (0) and the retardation value in the case of tilting by a degree of 50° toward the fast axis direction is R (50), the ratio of R (50)/R (0) being no less than 0.5 and no more than 1.1, more preferably no less than 0.8 and no more than 1.1, further preferably no less than 0.95 and no more than 1.05 can improve the visible angle characteristics because of a smaller difference of the retardation value in the front direction and the retardation value in the case of tilting.

These preferable substituent of the (C7 to C20) or (C8 to C20) aliphatic acyl groups are selected according to desired birefringence, viscosity, orientating ability, processability, reactivity and the like of cellulose derivative of the present invention. And the degree of substitution of an intended cellulose hydroxyl group is properly determined according to desired birefringence, viscosity, orientating ability, processability, reactivity and the like of cellulose derivative of the present invention.

A specific synthesis method for the cellulose derivative used in the present invention will be described below.

The cellulose derivative of the present invention can be obtained by reaction of the cellulose represented by Formula (3) and a reagent corresponding to the substituent. For example, cellulose impregnated in N,N-dimethylacetoamide is dissolved in a mixed solvent of lithium chloride and N,N-dimethylacetoamide, and then (C5 to C20) aliphatic carboxylic acid halide corresponding to the substituent is added thereto and reacted to obtain cellulose acylate in which hydroxyl groups of the cellulose are substituted by acyl groups. Further, as an alternative method to perform acylation, cellulose acylate can be similarly obtained by reacting cellulose in a mixed solvent of trifluoroacetic anhydride and (C5 to C20) carboxylic acid corresponding to the substituent. The degree of substitution of each cellulose derivative can be controlled by properly selecting reaction conditions of these reactions. For example, as for cellulose acylate, a method using the above carboxylic acid halide is preferable one when cellulose acylate having a degree of substitution of about 1.0 to about 2.8 is obtained. On the other hand, the method using trifluoroacetic anhydride and carboxylic acid is preferable one when cellulose acylate having a degree of substitution of about 2.5 to 3.0 is obtained. More rigorous control of degree of substitution can be achieved by appropriately adjusting an amount of each reagent to be used in reaction, reaction temperature, reaction time and the like. After completion of reaction, a product is precipitated by adding the reaction solution into water or methanol and purified by washing with water or methanol. A resulting solid is dried to obtain a cellulose derivative of the present invention.

Adjustment of the degree of substitution of a cellulose derivative of the present invention can be achieved by adjusting the amount of a reagent for introducing a substituent used in the synthesis of said cellulose derivative. The reagent for introducing a substituent can be used in a range of 0.5 to 100 equivalents to the quantity of hydroxyl group of cellulose to be used as a material of the reaction. A cellulose derivative having a higher degree of substitution can be obtained as more reagent is used. However, since the reagent for introducing a substituent has different reactivity to the hydroxyl group of the cellulose depending on the type of a reagent for introducing a substituent, the amount of a reagent for introducing a substituent necessary to achieve a given degree of substitution differs depending on each type. In addition, as an alternative method for adjusting the degree of substitution, hydrolyzing an obtained cellulose acylate using an alkaline aqueous solution such as potassium hydroxide or sodium hydroxide aqueous solution is included. A degree of hydrolyzing may be properly adjusted by the concentration and temperature of an alkaline aqueous solution, processing time and the like.

For example, when cellulose n-hexanate having a degree of substitution of 2.1 is obtained, the reaction is performed for 4 hours or more using 1.05 equivalents of n-hexanoyl chloride to the hydroxyl group of the cellulose. On the other hand, when cellulose n-hexanate having a degree of substitution of 2.7 is obtained, the reaction is performed for 4 hours or more using 1.50 equivalents of n-hexanoyl chloride to the hydroxyl group of the cellulose.

Furthermore, in order to improve tearing strength, the obtained cellulose ester and the above aliphatic compound for cross-linking are reacted. The reaction may be performed before film making described below, in a process during film making, or after stretching. In the case of performing the reaction before film making, for example, cellulose ester having a polymerizable group can be obtained by dissolving the above cellulose ester in an organic solvent and then adding an aliphatic compound for cross-linking thereto, further if required, heat treatment, or addition of a catalyst, a condensation agent and the like, followed by reaction. The obtained cellulose ester having a polymerizable group may be subjected to crystallization and purification with water and the like, otherwise directly used. Usually, the temperature of heat treatment is in the range of 20° C. to 160° C., and especially suitably in the range of 30° C. to 110° C.

Preparation of a retardation film of the present invention using the above cellulose derivative is performed by film making (and if required, polymerization reaction) from a solution of the cellulose derivative (including the above cellulose ester having polymerizable group) and orientating treatment. As a specific method, firstly, said cellulose derivative is dissolved in a solvent. The solvent to be used includes halogenated hydrocarbon solvents such as methylene chloride and chloroform; acetate esters such as ethyl acetate, butyl acetate and methyl acetate; alcohols such as methanol, ethanol, propanol, isopropanol and benzyl alcohol; ketones such as 2-butanone, acetone, cyclopentanone and cyclohexanone; basic solvents such as benzylamine, triethylamine and pyridine; and nonpolar solvents such as cyclohexane, benzene, toluene, xylene, anisole, hexane and heptane. Concentration by weight of said cellulose derivative is generally 1% to 99%, preferably 2.5% to 80%, and more preferably 5% to 50%. These compounds may be used alone or in combination of plural kinds. The above solvents and a plasticizer may be further added thereto if required. The plasticizer includes phthalate esters such as dimethyl phthalate, diethyl phthalate and ethylphthalylethyl glycolate; trimellitate esters such as tris(2-ethylhexyl)trimellitate; aliphatic dibasic acid esters such as dimethyl adipate and dibutyl adipate; orthophosphate esters such as tributyl phosphate and triphenyl phosphate; sebacic acid esters such as di-n-butyl sebacate; and acetate esters such as glycertriacetate and 2-ethylhexyl acetate. These compounds may be formulated alone or in combination of plural kinds.

Subsequently, the obtained solution of cellulose derivative is coated on a substrate having a flat and releasable surface, thereafter the solvent is removed by natural drying or heat drying and delaminated from said substrate to form a transparent cellulose derivative film. Otherwise, after the above cellulose ester to be used as a material for the above cellulose ester having polymerizable group is dissolved in the above halogenated hydrocarbon solvents such as methylene chloride and chloroform, ketones such as 2-butanone, acetone, cyclopentanone and cyclohexanone, basic solvent such as benzylamine, triethylamine and pyridine, acetic acid esters, alcohols, nonpolar solvent and the like, an aliphatic compound for cross-linking, and if required, a catalyst are added thereto and then similarly film making is performed. Then, cross-linking reaction is performed by heating while removing a solvent by drying, heat treatment or UV irradiation after removing a solvent, or the like to obtain a film composed of cross-linked cellulose derivatives. A cross-linking agent includes compounds having a functional group such as an isocyanate group, a thioisocyanate group or a carboxyl group, or a polymerizable group such as a vinyl group and a methacryloyl group. These cross-linking agents may be formulated alone or in combination of plural kinds.

By uniaxially stretching a thus obtained cellulose derivative film, a retardation film of the present invention can be obtained. For the stretching treatment, a typical uniaxially stretching can be employed, in which, for example, said cellulose derivative film, with the both ends fixed, is uniaxially stretched while heating. Alternatively, in the case of a long film in a roll shape, for example, the both ends of the film are fixed with nip rollers respectively and continuously stretched by a difference between the numbers of revolutions of the both rollers. The optimal stretching temperature varies depending on the substituent type of cellulose derivative or the degree of substitution of cellulose derivative.

The stretching temperature for forming a retardation film of the present invention obtained by uniaxially stretching a film composed of cellulose derivatives in which a hydroxyl group of cellulose is substituted by an acyl group having 5 to 20 carbon atoms is 50° C. to 200° C., more preferably approximately 50° C. to 180° C. For example, in the case of cellulose n-hexanate in which the degree of substitution of a hexanoyl group is 2.0 to 3.0, the stretching temperature is 90° C. to 160° C.

In addition, the stretching temperature for forming a retardation film of the present invention by stretching the above heat resistance cellulose derivative is preferably 40° C. to 160° C., more preferably approximately 45° C. to 140° C. For example, in the case of cellulose n-decanate in which degree of substitution of decanoyl group is not less than 2.2 and under 2.9, the temperature is 45° C. to 140° C.

Furthermore, the stretching temperature for forming a retardation film of the present invention by stretching the above cross-linked cellulose derivative is 40° C. to 160° C., more preferably approximately 45° C. to 140° C.

The stretching ratio may be 1.05 times to 5.0 times, more preferably approximately 1.1 times to 4.0 times, though it varies depending on the kind of a cellulose derivative, the thickness and the desired retardation value. For example, in the case of cellulose n-hexanate in which the degree of substitution of a hexanoyl group is 2.0 to 3.0, the stretching ratio is approximately 1.1 times to 3.0 times. As for stretching speed, as well as the stretching temperature, the optimum stretching speed varies depending on the type of a cellulose derivative, the stretching speed is generally not more than 5 times stretching/min, preferably not more than 3 times stretching/min, and more preferably not more than 2 times stretching/min.

In the case of uniaxially stretching said cellulose ester containing an aliphatic compound for cross-linking, a retardation film of the present invention using cross-linked cellulose derivative can be obtained by cross-linking by heat treatment, UV irradiation or the like after uniaxially stretching. And in the case of uniaxially stretching cellulose ester having a polymerizable group, a retardation film of the present invention can be obtained by polymerizing by UV irradiation or the like after uniaxially stretching.

Thus obtained retardation film of the present invention has a retardation value of approximately 10 to 600 nm at a wavelength of 550 nm in the front direction of the film.

And a retardation film obtained in the present invention has a thickness of 10 to 500 μm, preferably 20 to 300 μm, more preferably approximately 30 to 150 μm.

In the case of a retardation film of the present invention composed of cellulose n-pentanate having a degree of substitution of 2.0 to 2.8 or cellulose n-hexanate having a degree of substitution of 2.0 to 2.5, particularly preferable are a stretching ratio of 1.5 to 2.0 times and a thickness of 50 to 100 μm, because a retardation film which has such biaxial characteristics as nx>ny>nz wherein the above refractive index of stretching direction is nx, the refractive index of direction orthogonal to it in a plane is ny, and the refractive index of thickness direction is nz, and achromatic property in wavelength dispersion characteristics can be obtained only by the above general uniaxially stretching.

Further, in the case of a cellulose derivative substituted by a linear acyl group having 7 to 20 carbon atoms such as cellulose n-heptanate having a degree of substitution of 2.5 to 2.99, cellulose n-octanate, cellulose n-nonanate, cellulose n-decanate, cellulose n-undecanate, cellulose n-dodecanate, cellulose n-tridecanate, cellulose n-tetradecanate, cellulose n-pentadecanate, cellulose n-hexadecanate, cellulose n-heptadecanate, cellulose n-octadecanate, cellulose n-nanodecanate and cellulose n-eicosanate all having a degree of substitution of 1.0 to 2.99, more preferably a cellulose derivative substituted by an acyl group having 7 to 16 carbon atoms such as cellulose n-heptanate having a degree of substitution of 2.7 to 3.0, cellulose n-octanate, cellulose n-nonanate, cellulose n-decanate, cellulose n-undecanate, cellulose n-dodecanate, cellulose n-tridecanate, cellulose n-tetradecanate, cellulose n-pentadecanate and cellulose n-hexadecanate all having a degree of substitution of 2.0 to 3.0, a retardation film having the above biaxial characteristics of ny>nz>nx or nz≧ny>nx (nx represents a refractive index in the stretching direction, ny represents an refractive index in the direction orthogonal to it in the plane, and nz represents a refractive index in the thickness direction) and wavelength dispersion characteristics that the retardation value on the wavelength side longer than 550 nm is smaller than the retardation value at 550 nm and the retardation value on the wavelength side shorter than 550 nm is larger than the retardation value at 550 nm can be obtained by a general uniaxially stretching. Accordingly, a retardation film having biaxial characteristics and the above wavelength dispersion characteristics can be produced without troublesome methods such as laminating a shrinkable film described in Patent Literature 3.

A general uniaxially stretching includes, for example, a method in which said cellulose derivative film, with the both ends are fixed, is stretched by 1.05 times to 5.0 times, more preferably approximately 1.1 times to 4.0 times in one direction while heating at 40° C. to 200° C., more preferably approximately 50° C. to 180° C., or in the case of a long film in a roll shape, for example, a method in which the film, with the both ends fixed with nip rollers, is stretched by 1.05 times to 5.0 times, more preferably approximately 1.1 to 4.0 times, under a heating atmosphere of 40° C. to 200° C., more preferably approximately 50° C. to 180° C., continuously by a difference between the numbers of revolutions of the both rollers.

Furthermore, in the case of a retardation film of the present invention composed of cellulose n-decanate having a degree of substitution of no less than 2.2 and under 2.9, by adjusting the stretching ratio at 1.5 to 4.0 times and the thickness at 50 to 150 μm, an about quarter wavelength retardation film (the retardation value at a wavelength of 550 nm is 130 to 140 nm) having the above biaxial characteristics of ny>nz>nx wherein the refractive index of stretching direction is nx, the refractive index of direction orthogonal to it in a plane is ny, and the refractive index of thickness direction is nz can be obtained only by the above general uniaxially stretching.

In the case of using cellulose ester having a polymerizable group or containing a cross-linking agent in film making, when polymerization reaction or cross-linking reaction is not performed before stretching, polymerization reaction or cross-linking reaction can be performed by UV irradiation, heat treatment or the like after this stretching treatment to form a retardation film using a cross-linked cellulose derivative of the present invention.

A retardation film using a cross-linked cellulose derivative of the present invention preferably has a tearing strength of no less than 400 kg/cm². In this connection, using a tensile tester, tearing strength is measured by stretching at a stretching speed of 20 mm/minute at 25° C.

A retardation film of the present invention can be used in combination of other retardation films or polarizing films to impart various functions. For example, a composite retardation film of the present invention can be obtained by laminating another retardation film showing na>nb>nc, na>nb=nc, na=nb>nc, na=nb<nc, and na>nc>nb wherein na represents a largest refractive index in a film plane, nb represents a refractive index orthogonal to it in film plane and nc represents a refractive index in the thickness direction, and a retardation film of the present invention showing nx>ny>nz, ny>nz>nx or nz≧ny>nx, at a desired angle of each slow axis. This composite retardation film, having wavelength dispersion and visible angle characteristics different from each retardation film alone, allows higher functions. Specifically, for example, a composite retardation film obtained by laminating a retardation film of the present invention showing ny>nz>nx or nz≧ny>nx and another retardation film showing na>nb>nc, na>nb=nc, and na=nb>nc in order that each slow axis are parallel or orthogonal to each other, has visible angle dependency more improved than each film. In this connection, as a method for laminating, a method of laminating films together with an acrylic type pressure-sensitive adhesive or an adhesive is included. As a pressure-sensitive adhesive for laminating, an acrylic type pressure-sensitive adhesive is preferably used, and as an adhesive, various adhesives such as polyvinyl alcohols, urethanes, isocyanates and acrylic type or epoxies can be properly used. Other retardation films include retardation films obtained by uniaxially or biaxially stretching polycarbonate, polyallylate, polyether sulfone, a norbornene derivative, cycloolefin polymers, a cellulose derivative described in Patent Literatures 2 and 8 or the like, and the like. Further specifically, for example, using a pressure-sensitive adhesive or an adhesive, a composite retardation film of the present invention can be obtained by laminating a retardation film of the present invention having a retardation being approximately half a wavelength (for example, the retardation value is approximately 200 nm to 300 nm, more preferably 230 nm to 290 nm, based on a light having a wavelength of 550 nm) and another retardation film having a retardation being approximately quarter a wavelength (for example, the retardation value is approximately 100 nm to 150 nm based on a light having a wavelength of 550 nm), which shows na>nb>nc or na>nb=nc and composed of uniaxially stretched polycarbonate, polyallylate, polyether sulfone, cycloolefin polymer, or the like, otherwise by laminating another retardation film having a retardation being approximately half a wavelength (for example, the retardation value is approximately 200 nm to 300 nm, more preferably 230 nm to 290 nm, based on a light having a wavelength of 550 nm) and a retardation film of the present invention having a retardation being approximately quarter a wavelength (for example, the retardation value is approximately 100 nm to 150 nm based on a light having a wavelength of 550 nm), which shows ny>nz>nx or nz≧ny>nx, so that the fast axis of a retardation film of the present invention (nx direction, that is, stretching direction) is substantively parallel to the slow axis of another retardation film (stretching direction). This composite retardation film is an achromatic (having almost the same retardation to each wavelength), quarter wavelength retardation film with a wide visible angle. In this connection, when the slow axis of another retardation film is in a longer direction and the fast axis of a retardation film of the present invention is in a longer direction, a layer of pressure-sensitive adhesive is prepared on the lamination surface side of another retardation film to allow lamination of a retardation film of the present invention by the roll to roll method and cost reduction from the simplification of process can be achieved.

Further, combination use of the present retardation film and a polarizing film can be improved a characteristic feature such as wide visible angle, less leak of light (or less omitting of color) and less color shift of a liquid crystal display. For Example, a circularly or elliptically polarizing film or a rotary polarizing film of the present invention can be obtained by laminating a retardation film or a composite retardation film of the present invention and a polarizing film. Specifically, for example, a circularly polarizing film of the present invention can be obtained by laminating a retardation film of the present invention having a retardation at 550 nm being approximately quarter a wavelength (for example, a retardation value of about 100 nm to 150 nm, preferably 130 to 140 nm, based on a light having a wavelength of 550 nm) so that the angle formed by the absorption axis of the polarizing film and the slow axis of said retardation film is 45° or 135°. In this connection, when the retardation film is a retardation film of the present invention having an achromatic property, visibility, color reproducibility and contrast can be improved by using it for reflection type or semi-transmission reflection type liquid crystal display devices. And, when it is used for organic electroluminescence type display devices, visibility of a display image is dramatically improved because reflection in an electrode section can be controlled. Also, when the retardation film is a retardation film of the present invention having biaxial characteristics, visible angle characteristics of liquid crystal display devices can be improved by using it for reflection type or semi-transmission reflection type liquid crystal display devices. And, when it is used for organic electroluminescence type display devices, similarly visible angle characteristics can be improved because the reflection in an electrode section can be controlled even in the case of observing from a tilted angle. Also, when a polarizing film and a retardation film of the present invention are laminated at an angle of the absorption axis of a polarizing film and the slow axis of a retardation film of the present invention other than 45° or 135°, an elliptically polarizing film of the present invention can be obtained. By using such an elliptically polarizing film for STN (super twisted nematic) type liquid crystal display devices, contrast of a display image and visible angle characteristics can be improved. In this connection, when contrast is improved, such optimization of retardation value and lamination angle as compensate a retardation value of STN type liquid crystal cell is required.

Next, a rotary polarizing film of the present invention can be obtained by laminating a retardation film of the present invention having a retardation at 550 nm being approximately half the wavelength (for example, a retardation value of about 200 nm to 300 nm, preferably 250 to 290 nm based on a light having a wavelength of 550 nm) so that the angle formed by the absorption axis of the polarizing film and the slow axis of said retardation film is 45° or 135°. When a retardation film to be used is a retardation film of the present invention having an achromatic property, using this rotary polarizing film for liquid crystal projectors allows uniform direction change of a linearly polarized light in a wide range of wavelength to improve light utilization efficiency, prevent deterioration of a polarizing film caused by light absorption and improve contrast of a display image. And, when a retardation film to be used is a retardation film of the present invention having biaxial characteristics, decreasing optical rotation caused by change of retardation value from tilting can be prevented.

Further, an optical film of the present invention can be obtained by laminating a retardation film or a composite retardation film of the present invention and a polarizing film so that their slow axis are parallel or orthogonal, more preferably orthogonal, to each other. This optical film can be also a wide visible angle polarizing film having visible angle dependency of the polarizing film improved. Furthermore, this optical film can be used as high performance polarizing film to improve a characteristic feature such as less leak of light (or less omitting of color) and less color shift of a liquid crystal display.

For Example, a composite optical film can be prepared by laminating a film where ne−no<0 (wherein no represents an average refractive index in a film plate, ne represents a refractive index in thickness direction), Rth calculated from Rth=(no−ne)×d (wherein d represents a thickness) is 100 to 300 nm and the retardation value in the front direction at 550 nm is 0 to 50 nm, the present retardation film and a polarizing film in this order so that the slow axis of the retardation film and the absorption axis of a polarizing element are orthogonal to each other. This composite optical film can be used to improve visible angle in a liquid crystal display devices. Especially, visible angle of a liquid crystal display devices using a vertical alignment liquid crystal cell can be improved by use of this composite optical film.

Typically, when two polarizing films are laminated so that each absorption axis is orthogonal to each other (cross-Nicol), there is a problem that light goes through at the position tilted from the front direction toward a direction different from each absorption axis, especially a direction by 45° from the absorption axis direction in a film plane even though light transmission from the front direction to a film surface can be blocked. The larger the tilt angle becomes, the more notable this is. However, in view of such visible angle dependency of polarizing film, using at least one optical film of the present invention, another polarizing film (it may be a typical polarizing film or a wide visible angle polarizing film which is one embodiment of the present invention) is laminated so that a retardation film of the present invention is sandwiched and each absorption axis orthogonal to each other(cross-Nicol), so light transmission can be controlled even in the case of observing from a direction different from each absorption axis, especially a direction tilted by 45° from the front direction. Specifically, a wide visible angle polarizing film which is another embodiment for an optical film of the present invention can be obtained by laminating a retardation film of the present invention having a biaxial property in which the retardation value is 50 to 300 nm, preferably 200 nm to 300 nm, more preferably 230 nm to 290 nm at a wavelength of 550 nm and a polarizing film so that the fast axis of the retardation film of the present invention and the absorption axis of the polarizing film are substantially parallel to each other. In this connection, when the polarizing film is longer, whose absorption axis is in the longer direction, and the retardation film of the present invention is longer, whose fast axis is in the longer direction, a layer of a pressure-sensitive adhesive or an adhesive is prepared on the lamination surface side of a film to allow lamination by the roll to roll method and cost reduction from the simplification of process can be achieved. Furthermore by using this optical film for IPS (in-plane switching) type liquid crystal display devices or VA (vertical alignment: vertical orientation) type liquid crystal display devices, visible angle dependency of liquid crystal display devices can be improved.

Visible angle characteristics of VA type liquid crystal display devices can be improved by using an optical film of the present invention laminated so that the slow axis of a retardation film of the present invention showing nx>ny>nz which has a retardation value of 50 to 300 nm, more preferably 100 to 300 nm at a wavelength of 550 nm and having an achromatic property or a retardation film of the present invention showing ny>nz>nx or nz≧ny>nx and wavelength dispersion characteristics having biaxial characteristics that the retardation value on the wavelength side longer than 550 nm is smaller than the retardation value at 550 nm and the retardation value on the wavelength side shorter than 550 nm is larger than the retardation value at 550 nm, and the absorption axis or the penetration axis of a polarizing film are parallel or orthogonal to each other, more preferably the slow axis of a retardation film and the absorption axis of a polarizing film are orthogonal to each other, and using a retardation film having a relation of ne−no<0 wherein the average refractive index in a film plane is no and the refractive index of thickness direction is ne. A film showing ne−no<0 includes, for example, a retardation film described in JP 2004-082714 which is biaxially stretched in a film plane, a film described in JP 2003-315556 wherein a cholesteric liquid crystal having a selective reflection range in an ultraviolet region is oriented and fixed, a film described in JP 2866372 fixed wherein discotic liquid crystal is oriented so that a disk plane is approximately horizontal to the substrate plane, a film formed by laminating two uniaxially stretched films so that each slow axis is orthogonal to each other, or the like. Specifically, in order to improve visible angle characteristics of VA type liquid crystal display devices, when the thickness of a film being ne−no<0 is d, Rth calculated from Rth=(no−ne)×d is preferably approximately 100 to 300 nm, and such Rth can be achieved by adjusting ne, no and d properly. In this connection, the retardation value of the film front direction at 550 nm is preferably approximately 0 to 50 nm. A composite optical film of the present invention can be obtained by laminating such a film as ne−no<0, and a retardation film of the present invention (when there is a retardation in the front direction of such a film as ne−no<0, by laminating so that the slow axis of said film and the slow axis direction of a retardation film of the present invention is parallel or orthogonal to each other), and further by laminating a polarizing film on the side of the retardation film of the present invention. Lamination can be performed using an acrylic type or silicone type of a pressure-sensitive adhesive or an adhesive. Especially, using a retardation film of the present invention as a substrate and forming an oriented discotic liquid crystal layer or a cholesteric liquid crystal layer having a selective reflection range in an ultraviolet region on said retardation film (if required, further, orientation film is formed on said retardation film, on said orientation film) allow thinning and simplification of process because another substrate to form a liquid crystal layer is not necessary.

As the above polarizing film to be used in the present invention, a polarizing film with a structure having a support film on at least one side of a polarizing element is used. As the polarizing element, for example, a polarizing element having a thickness of approximately 10 to 40 μm obtained by uniaxially stretching a polyvinyl alcohol film wherein dichroic coloring matter such as iodine (poly-iodine ion) or dichroic colorant is absorbed and oriented, and then if required, by cross-linking treatment with boric acid, or a polyene type polarizing element having a thickness of approximately 10 to 40 μm obtained by dehydration treatment after a polyvinyl alcohol film is uniaxially stretched can be used. A polarizing film to be used in combination is also preferably excellent in heat resistance because a retardation film of the present invention has improved heat resistance, so a polarizing element produced using dichroic colorant is more preferable. As the support film, for example, a triacetyl cellulose film having a thickness of approximately 40 to 100 μm in which a surface layer is subjected to saponification treatment, and a film composed of cycloolefin polymer such as Arton (manufactured by JSR Corporation) and Zeonor(manufactured by Zeon Corp.) can be used. These support films are laminated to a polarizing element with an adhesive. A general polarizing film is structured by laminating the above support film to the both sides of a polarizing element using an adhesive. In this connection, producing a thin circularly polarizing film, a thin rotary polarizing film, a thin elliptically polarizing film, a thin optical film and a thin composite optical film, all of the present invention, obtained by replacing with a retardation film of the present invention at least one of the above support films, which allows not only providing functions as a support film for a polarizing element but also simplifying laminating processes with a pressure-sensitive adhesive and the like, and reducing a whole film thickness, is particularly preferred.

Adhesion of a retardation film of the present invention and a polarizing element can be achieved using, for example, isocyanate type or acrylic emulsion type adhesive, however, a retardation film of the present invention has the characteristic that its surface layer is subjected to saponification treatment by immersing in an alkaline aqueous solution, resulting in improving its hydrophilic property. Accordingly a retardation film of the present invention subjected to saponification treatment can also be bonded, when used as a support film, directly to a polarizing element comprised in a polarizing film using a poly(vinyl alcohol) type water-soluble adhesive. Such a retardation film of the present invention subjected to saponification treatment can be bonded, when used as at least one of the support films, directly to a polarizing element using a polyvinyl alcohol type water-soluble type adhesive, similarly to a usual support film. Thus obtained circularly polarizing film, rotary polarizing film, elliptically polarizing film, optical film and composite optical film of the present invention allows cost reduction from simplification of process and thinning compared with a case in which a retardation film of the present invention is additionally laminated to a usual polarizing film with a pressure-sensitive adhesive or the like, because a retardation film of the present invention functions as a substrate of a polarizing film. In this connection, saponification treatment is achieved, for example, by immersion in an alkaline aqueous solution such as an aqueous solution of sodium hydroxide or potassium hydroxide for a certain time followed by washing with water. An aqueous solution of sodium hydroxide or potassium hydroxide has a concentration of 0.5 to 6N and a temperature of approximately 10 to 60° C. and the immersion time is properly adjusted depending on the degree of saponification treatment. The degree of saponification treatment can be determined by measuring a contact angle of water on a film plane subjected to the treatment using a contact angle meter. The saponification treatment on a retardation film of the present invention is preferably carried out so that the contact angle of water on the front surface of a retardation film of the present invention after saponification treatment is not less than 5° and not more than 60°, preferably not less than 5° and not more than 50°, more preferably not less than 5° and not more than 30°.

By using thus obtained circularly polarizing film of the present invention combined with a function of a substrate of a polarizing film for image display devices such as organic EL (electroluminescence) type display devices or liquid crystal display devices, visible angle characteristics and contrast of a displayed image can be improved. In the case of organic EL type display devices, for example, by using an achromatic wide visible angle circularly polarizing film which is one embodiment for the above optical film of the present invention on the side of display surface as a circularly polarizing film to prevent reflection of metal electrode, a high anti-reflection effect is provided at each wavelength, so contrast of a display image can be improved. And in the case of liquid crystal display devices, by using an achromatic wide visible angle circularly polarizing film which is one embodiment for the above optical film of the present invention as a circularly polarizing film in reflection type or semi-transmission reflection type liquid crystal display devices, a high anti-reflection effect is maintained at each wavelength in the case of observing not only from the front direction but also from a tilted angle, so contrast of a display image is improved, resulting that the same image as from the front can be seen from a tilted angle, and therefore visible angle characteristics can be improved. Further, in the case of TN type or OCB (bend orientation) type liquid crystal display devices, compensation of TN (twisted nematic) type liquid crystal cell can be achieved using a film having a hybrid-oriented discotic liquid crystal layer as described in JP 2003-315556, but visible angle characteristics of a polarizing film itself cannot be improved. The same is true in OCB type liquid crystal cell. However, by using a wide visible angle polarizing film which is one embodiment for an optical film of the present invention in combination with a TN type liquid crystal cell compensation film, further wide visualization is allowed. And similarly, in VA type liquid crystal display devices, wider visualization is allowed by using an composite optical film of the present invention laminated with the above film showing ne−no<0, a retardation film showing nx>ny>nz and having an achromatic property, and a polarizing film in this order, or by using an optical film of the present invention in combination with VA liquid crystal cell compensation film after achievement of compensation of VA type liquid crystal cell itself using a compensation film as described in JP 2866372, JP 2002-196137 and JP 2587398. For example, wider visualization is allowed by using an optical film composed of a retardation film of the present invention showing ny>nz>nx or nz≧ny>nx and biaxial characteristics in wavelength dispersion characteristics such that the retardation value on the wavelength side longer than 550 nm is smaller than the retardation value at 550 nm and the retardation value on the wavelength side shorter than 550 nm is larger than the retardation value at 550 nm and an polarizing film after compensating a liquid crystal cell itself with a compensation film compensating each liquid crystal cell such as TN type, OCB type, VA type and IPS (in-plane switching) type liquid crystal cells. In this connection, by using a thin type wide visible angle polarizing film which is one embodiment for a thin type optical film of the present invention (one produced by saponification treatment of a retardation film of the present invention and bonding it to a polarizing element with an adhesive) instead of a wide visible angle polarizing film, the whole thickness of a liquid crystal display device of the present invention can be reduced.

As described above, image display devices of the present invention including organic electroluminescence type display devices, liquid crystal projectors, liquid crystal display devices and the like having a circularly polarizing film, a rotary polarizing film, an elliptically polarizing film, an optical film and a composite optical film produced by using a retardation film of the present invention can impart such excellent characteristics that contrast and visible angle characteristics are improved compared with conventional image display devices.

FIG. 7 is an example wherein the present laminated film is used at an electroluminescence part of organic electroluminescence type display devices,

FIG. 8 is an example wherein the present laminated film is used at a backlight part or reflector part in liquid crystal display devices having backlight or reflector.

### EXAMPLES

Hereinafter, the present invention will be explained more specifically.

In this connection, as cellulose to be used as a material in the following examples, cellulose having a unit number (degree of polymerization) of about 300 and which unit is represented by Formula (3) (produced by Miki & Co., Ltd.) was used.

### Example 1

Cellulose (produced by Miki & Co., Ltd.) was impregnated in dimethylacetoamide to obtain dimethylacetamide-impregnated cellulose having a cellulose content of 56.4%. Next, 12.6 g of lithium chloride was added to 150 mL of dimethylacetoamide and stirred for 30 minutes at 80° C. until complete dissolution, followed by adding 3.0 g of dimethylacetamide-impregnated cellulose thereto. After stirring for 30 minutes at 50° C., 6.5 mL of n-valeroyl chloride was added thereto and the temperature was raised again to 80° C. followed by stirring for 2.5 hours. The stirring was stopped and the reaction content was poured in 2 liters of water to reciprocate cellulose n-pentanate. After collection by filtration, a solid content obtained by washing three times with 100 mL of water and twice with 50 mL of methanol was vacuum-dried for 6 hours to obtain 3.2 g of white powder of cellulose n-pentanate.

Next, the resulting cellulose n-pentanate was dissolved in a mixed solvent of acetone/DMSO and hydrolyzed using a 1N sodium hydroxide aqueous solution. At the same time, as a blank, a solution in which the same amount of 1N sodium hydroxide aqueous solution as the above was charged in a mixed solution of acetone/DMSO was prepared. Back titrations of the both solutions with 1N sulfuric acid were carried out to determine the degree of substitution (number of substitution by n-pentanate group per one cellulose monomer unit), resulting in 2.29.

Next, this cellulose n-pentanate was dissolved in cyclopentanone to be a 10% by weight solution. This solution was coated on a flat and smooth polyester film using a comma coater (manufactured by HIRANO TECSEED Co., Ltd.), and after a solvent was removed by heat, a film of cellulose n-pentanate was obtained by delamination from a polyester film.

Next, this film was cut out in rectangles, with the both ends fixed, stretched until reaching 2 times of the original length under a condition of 150° C. and cooled to room temperature to obtain a retardation film of the present invention (thickness: 77 μm, retardation value at 550 nm: 132 nm). The refractive index of this retardation film was determined using an Abbe refractometer (Abbe refractometer 1 T, manufactured by Atago Co., Ltd.), resulting in the refractive index in the stretching direction: nx=1.4827, the refractive index in the direction orthogonal to the stretching direction in a film plane: ny=1.4810, the refractive index in the thickness direction: nz=1.4805. Further, each retardation value at each wavelength was determined using an automatic birefringence meter (KOBRA-21ADH, manufactured by Oji Scientific Instruments Co., Ltd.) to calculate the ratio (retardation ratio: Ren/Re550) of the retardation value at 550 nm (Re550) and each retardation value at each wavelength (Ren), and wavelength dispersion characteristics obtained from the results are shown in FIG. 1. In this connection, the slow axis of this retardation film was in the direction parallel to the stretching direction.

### Example 2

By the same operation as in Example 1 except that 3.6 mL of n-hexanoyl chloride was used instead of n-valeroyl chloride, cellulose n-hexanate was obtained. The resulting cellulose n-hexanate was determined in the same manner as in Example 1, resulting in that the degree of substitution (number of substitution by n-hexanoyl group per one cellulose monomer unit) was 2.43. Next, by the same operation in Example 1 except that cellulose n-hexanate was dissolved in cyclopentanone to be a 20% by weight solution, a film of cellulose n-hexanate was obtained. This film was cut out in rectangles, with the both ends fixed, stretched until reaching 1.8 times of the original length under a condition of 120° C. and cooled to room temperature to obtain a retardation film of the present invention (thickness: 85 μm, retardation value at 550 nm: 139 nm). The refractive index of this retardation film was determined in the same manner as in Example 1, resulting in the refractive index in the stretching direction: nx=1.4821, the refractive index in the direction orthogonal to the stretching direction in a film plane: ny=1.4805, and the refractive index in the thickness direction: nz=1.4795. Further, the wavelength dispersion characteristics determined by the same operation as in Example 1 are shown in FIG. 1. In this connection, the slow axis of this retardation film was in the direction parallel to the stretching direction.

### Example 3

A mixed solution of 48 mL of n-heptanoic acid and 39.6 mL of trifluoroacetic anhydride was heated to 55° C. and stirred for 20 minutes. Next, 1.55 g of cellulose (produced by Miki & Co., Ltd.) was added to said mixed solution maintained at 55° C. and stirred for 5 hours. Next, this mixture was added in 1000 mL of methanol to separate out a precipitate. This was collected by suction filtration and the precipitate on the filtration paper was sufficiently washed with ethyl acetate and vacuum-dried at 40° C. to obtain 3.86 g of cellulose n-heptanate.

Next, the degree of substitution was determined by the same operation as in Example 1, resulting in 2.9.

Next, the resulting cellulose n-heptanate was dissolved in chloroform to prepare a 5% by weight solution and a film of cellulose n-heptanate was obtained by the same operation as in Example 1. This film was cut out in rectangles and the both ends on the short side were fixed, one of which was uniaxially stretched in the longitudinal direction until reaching 2.0 times of the original length under an atmosphere of 80° C. to obtain a retardation film of the present invention. The film thickness of this retardation film was about 95 μm. Next, using an automatic birefringence meter (KOBRA-21ADH, manufactured by Oji Scientific Instruments Co., Ltd.), the retardation value at 590 nm was determined, resulting in 266 nm. Next, wavelength dispersion characteristics were determined in the same manner as in Example 1, resulting in that the retardation value on the wavelength side longer than 550 nm was smaller than the retardation value at 550 nm and the retardation value on the wavelength side shorter than 550 nm was larger than the retardation value at 550 nm.

Also, using an Abbe refractometer (Abbe refractometer 1 T, manufactured by Atago Co., Ltd.), the refractive indexes of the resulting retardation film of the present invention were determined, resulting in the refractive index in the stretching direction: nx=1.4732, the refractive index in the direction orthogonal to the stretching direction in a film plane: ny=1.4760, and the refractive index in the thickness direction: nz=1.4750.

### Example 4

In the same manner as in Example 3 except that 48 mL of n-octanoic acid instead of n-heptanoic acid, 35.4 mL of trifluoroacetic anhydride and 1.38 g of cellulose (produced by Miki & Co., Ltd.) were used, 3.16 g of cellulose n-octanate was obtained. Next, by the same operation as in Example 1, the degree of substitution was determined, resulting in 2.9. Using this cellulose n-octanate, a cellulose n-octanate film was prepared by the same operation as in Example 3. Next, by the same operation as in Example 3 except that the film was uniaxially stretched reaching 2.0 times of the original length at a stretching temperature of 60° C., a retardation film of the present invention was obtained. The film thickness of this retardation film was about 95 μm. The retardation value of the resulting retardation film was determined similarly to Example 3, resulting in that the retardation value at 590 nm was 370 nm. Also, the refractive indexes of the resulting retardation film were determined similarly to Example 3, resulting in the refractive index in the stretching direction: nx=1.4720, the refractive index in the direction orthogonal to the stretching direction in a film plane: ny=1.4759, and the refractive index in the thickness direction: nz=1.4730. Next, wavelength dispersion characteristics of this retardation film were determined by the same operation as in Example 1. The results are shown in FIG. 1. Judging from FIG. 1, it is found that the retardation value on the wavelength side longer than 550 nm is smaller than the retardation value at 550 nm and the retardation value on the wavelength side shorter than 550 nm is larger than the retardation value at 550 nm. In this connection, the slow axis of this retardation film was in the direction orthogonal to the stretching direction.

### Example 5

In the same manner as in Example 3 except that 49.9 g of n-decanoic acid instead of n-heptanoic acid, 33.8 mL of trifluoroacetic anhydride and 1.32 g of cellulose (produced by Miki & Co., Ltd.) were used, 3.77 g of cellulose n-decanate was obtained. Next, the degree of substitution was determined by the same operation as in Example 1, resulting in that the degree of substitution was 2.9. Using this cellulose n-decanate, an unstretched film of cellulose n-decanate was prepared by the same operation as in Example 3. Next, by the same operation as in Example 3 except that the film was uniaxially stretched until reaching 2.0 times of the original length at a stretching temperature of 50° C., a retardation film of the present invention was obtained. The film thickness of this retardation film was about 95 μm. The retardation value of the resulting retardation film was determined similarly to Example 3, resulting in that the retardation value at 590 nm was 267 nm. And, the refractive indexes of the resulting retardation film was determined similarly to Example 3, resulting in the refractive index in the stretching direction: nx=1.4712, the refractive index in the direction orthogonal to the stretching direction in a film plane: ny=1.4740, and the refractive index in the thickness direction: nz=1.4760. Next, wavelength dispersion characteristics of this retardation film were determined by the same operation as in Example 1.

It is found that the retardation value on the wavelength side longer than 550 nm is smaller than the retardation value at 550 nm and the retardation value on the wavelength side shorter than 550 nm is larger than the retardation value at 550 nm. In this connection, the slow axis of this retardation film was in the direction orthogonal to the stretching direction.

### Example 6

In the same manner as in Example 3 except that 14.3 g of lauric acid was used instead of n-heptanoic acid, 8.96 g of cellulose n-laurate was obtained. Next, the degree of substitution was determined by the same operation as in Example 1, resulting in that the degree of substitution was 2.9. Using this cellulose n-laurate, an unstretched film of cellulose n-laurate was prepared by the same operation as in Example 3. Next, by the same operation as in Example 3 except that the film was uniaxially stretched until reaching 1.5 times of the original length at a stretching temperature of 80° C., a retardation film of the present invention was obtained. The film thickness of this retardation film was 130 μm. The retardation value of the resulting retardation film was determined similarly to Example 3, resulting in that the retardation value at 590 nm was 250 nm. And, the refractive indexes of the resulting retardation film were determined similarly to Example 3, resulting in the refractive index in the stretching direction: nx=1.4790, the refractive index in the direction orthogonal to the stretching direction in a film plane: ny=1.4810, and the refractive index in the thickness direction: nz=1.4818. Next, wavelength dispersion characteristics of this retardation film were determined by the same operation as in Example 1. The results are shown in FIG. 1. Judging from FIG. 1, it is found that the retardation value on the wavelength side longer than 550 nm is smaller than the retardation value at 550 nm and the retardation value on the wavelength side shorter than 550 nm is larger than the retardation value at 550 nm. In this connection, the slow axis of this retardation film was in the direction orthogonal to the stretching direction.

### Example 7

In the same manner as in Example 3 except that 50 g of palmitic acid was used instead of n-heptanoic acid, 5.84 g of white powder of cellulose n-palmitate was obtained. Next, the degree of substitution was determined by the same operation as in Example 1, resulting in that the degree of substitution was 2.9. Using this cellulose n-palmitate, an unstretched film of cellulose n-palmitate was prepared by the same operation as in Example 3. Next, by the same operation as in Example 3 except that the film was uniaxially stretched until reaching 1.5 times of the original length at a stretching temperature of 60° C., a retardation film of the present invention was obtained. The film thickness of this retardation film was about 80 μm. The retardation value of the resulting retardation film was determined similarly to Example 3, resulting in that the retardation value at 590 nm was 120 nm. And, the refractive indexes of the resulting retardation film were determined similarly to Example 3, resulting in the refractive index in the stretching direction: nx=1.4900, the refractive index in the direction orthogonal to the stretching direction in a film plane: ny=1.4915, and the refractive index in the thickness direction: nz=1.4925. Next, wavelength dispersion characteristics of this retardation film were determined by the same operation as in Example 1. The results are shown in FIG. 1. Judging from FIG. 1, it is found that the retardation value on the wavelength side longer than 550 nm is smaller than the retardation value at 550 nm and the retardation value on the wavelength side shorter than 550 nm is larger than the retardation value at 550 nm. In this connection, the slow axis of this retardation film was in the direction orthogonal to the stretching direction.

### Example 8

Cellulose (produced by Miki & Co., Ltd.) was impregnated in dimethylacetoamide to obtain dimethylacetamide-impregnated cellulose having a cellulose content of 52.8%. Next, after 16.6 g of lithium chloride was added to 200 mL of dimethylacetoamide and stirred at 80° C. until complete dissolution, 4.0 g of dimethylacetamide-impregnated cellulose was added thereto. While stirring at 50° C., 12.7 g of n-octanoyl chloride was added thereto and the temperature was raised again to 80° C., followed by stirring for 3.5 hours. The stirring was stopped and the reaction content was poured in 400 mL of water to crystallize cellulose n-octanate. After collection by filtration, it was washed with 400 mL of 50% water-containing methanol. Further, a solid content obtained by washing twice with 200 mL of methanol was vacuum-dried to obtain 6.3 g of white powder of cellulose n-octanate. The degree of substitution (number of substitution by n-octanate group per one cellulose monomer unit) was determined, resulting in 2.87. The degree of substitution of cellulose n-octanate was calculated form the ratio of the peak area of seven hydrogens in one cellulose monomer unit and the peak area of three hydrogens of an end methyl group of an octyl group, using a NMR (300 MHz, manufactured by Varian, Inc.).

### Example 9

After 62.5 g of lithium chloride was added to 700 mL of dimethylacetoamide and stirred at 80° C. until complete dissolution, 15.0 g of dimethylacetamide-impregnated cellulose obtained in Example 8 was added thereto. While stirring at 50° C., 28.0 g of n-decanoyl chloride was added thereto and the temperature was raised again to 80° C., followed by stirring for 3.5 hours. The stirring was stopped and the reaction content was poured in 2000 mL of water to crystallize cellulose n-decanate. After collection by filtration, it was washed with 1000 mL of 50% water-containing methanol. Further, a solid content obtained by washing twice with 500 mL of methanol was vacuum-dried to obtain 23.0 g of white powder of cellulose n-decanate. The degree of substitution (number of substitution by n-decanate group per one cellulose monomer unit) was determined, resulting in 2.48. The degree of substitution of cellulose n-decanate was calculated by determining the amount of residual carboxylic acid at the moment when the reaction was completed by adding water, using a gas chromatography (HP-5890, manufactured by Agilent Technologies).

### Example 10

After 16.6 g of lithium chloride was added to 200 mL of dimethylacetoamide and stirred at 80° C. until complete dissolution, 4.0 g of dimethylacetamide-impregnated cellulose obtained in Example 8 was added thereto. While stirring at 50° C., 9.4 g of n-dodecanoyl chloride was added thereto and the temperature was raised again to 80° C., followed by stirring for 3.5 hours. The stirring was stopped and the reaction content was poured in 500 mL of water to crystallize cellulose n-dodecanate. After collection by filtration, it was washed with 400 mL of 50% water-containing methanol. Further, a solid content obtained by washing with 300 mL of methanol and then washing twice with 300 mL of acetone, was vacuum-dried to obtain 5.7 g of white powder of cellulose n-dodecanate. The degree of substitution (number of substitution by n-dodecanate group per one cellulose monomer unit) was determined, resulting in 2.16. The degree of substitution of the cellulose n-dodecanate was calculated from the ratio of the peak area of seven hydrogens in one cellulose monomer unit and the peak area of three hydrogens of an end methyl group of a dodecyl group, using a NMR (300 MHz, manufactured by Varian, Inc.).

### Example 11

After 16.6 g of lithium chloride was added to 200 mL of dimethylacetoamide and stirred at 80° C. until complete dissolution, 4.0 g of dimethylacetamide-impregnated cellulose obtained in Example 8 was added thereto. While stirring at 50° C., 11.7 g of n-octanoyl chloride was added thereto and the temperature was raised again to 80° C., followed by stirring for 3.5 hours. The stirring was stopped and the reaction content was poured in 500 mL of water to crystallize cellulose n-octanate. After collection by filtration, it was washed with 200 mL of 50% water-containing methanol. Further, a solid content obtained by washing twice with 200 mL of methanol was vacuum-dried to obtain 7.5 g of white powder of cellulose n-octanate. The degree of substitution (number of substitution by n-octanate group per one cellulose monomer unit) was determined, resulting in 2.86. The degree of substitution of the cellulose n-octanate was calculated similarly to Example 8, using a NMR (300 MHz, manufactured by Varian, Inc.).

### Example 12

The cellulose n-octanate synthesized in Example 8 was dissolved in chloroform to be a 12% by weight solution. After this solution was coated on a releasing film (PET3801, manufactured by Lintec Corp.) using a comma coater and dried at 40° C. to remove the solvent, a film was formed by delamination from the releasing film. This film was cut out in rectangles, with the both ends fixed, stretched until reaching about 4 times of the original length under a condition of 100° C. and cooled to room temperature to obtain a retardation film of the present invention (thickness: 87 μm, retardation value at 590 nm: 387 nm). The slow axis of this retardation film was orthogonal to the stretching direction.

The change in the retardation value when the retardation film was tilted to the slow axis and the fast axis directions respectively to 50°, that is, visible angle characteristics of the retardation film was determined, using an automatic birefringence meter (KOBRA-21ADH, manufactured by Oji Scientific Instruments Co., Ltd.) to calculate Rn/Ro, the ratio of the retardation value Rn at a wavelength 590 nm in a tilt angle n° to the retardation value Ro at a wavelength of 590 nm in the front direction (0°). The results are shown in FIG. 2. And, the refractive indexes of the resulting retardation film of the present invention were determined using an Abbe refractometer (Abbe refractometer 1 T, manufactured by Atago Co., Ltd.), resulting in the refractive index in the stretching direction: nx=1.4736, the refractive index in the direction orthogonal to the stretching direction in a film plane: ny=1.4774, and the refractive index in the thickness direction: nz=1.4774.

### Example 13

By the same operation as in Example 12 except that cellulose n-decanate synthesized in Example 9 was dissolved in chloroform to be a 15% by weight solution, a film was prepared. This film was cut out in rectangles, with the both ends fixed, stretched until reaching about 2 times of the original length under a condition of 75° C. and cooled to room temperature to obtain a retardation film of the present invention (thickness: 100 μm, retardation value at 590 nm: 108 nm). The slow axis of this retardation film was orthogonal to the stretching direction. The change in the retardation value when the retardation film was tilted to the slow axis and the fast axis directions to 50° respectively, that is, visible angle characteristics of the retardation film was determined, using an automatic birefringence meter (KOBRA-21ADH, manufactured by Oji Scientific Instruments Co., Ltd.) to calculate Rn/Ro, the ratio of the retardation value Rn at a wavelength 590 nm in a tilt angle n° to the retardation value Ro at a wavelength of 590 nm in the front direction (0°). The results are shown in FIG. 2. And, the refractive indexes of the resulting retardation film of the present invention were determined using an Abbe refractometer (Abbe refractometer 1 T, manufactured by Atago Co., Ltd.), resulting in the refractive index in the stretching direction: nx=1.4757, the refractive index in the direction orthogonal to the stretching direction in a film plane: ny=1.4770, and the refractive index in the thickness direction: nz=1.4762.

### Example 14

By the same operation as in Example 12 except that cellulose n-dodecanate synthesized in Example 10 was dissolved in chloroform to be a 10% by weight solution, a film was prepared. This film was cut out in rectangles, with the both ends fixed, stretched until reaching about 2 times of the original length under a condition of 57° C. and cooled to room temperature to obtain a retardation film of the present invention (thickness: 125 μm, retardation value at 590 nm: 192 nm). The slow axis of this retardation film was orthogonal to the stretching direction. The change in the retardation value when the retardation film was tilted to the slow axis and the fast axis directions to 50° respectively, that is, visible angle characteristics of the retardation film was determined, using an automatic birefringence meter (KOBRA-21ADH, manufactured by Oji Scientific Instruments Co., Ltd.) to calculate Rn/Ro, the ratio of the retardation value Rn at a wavelength 590 nm in a tilt angle n° to the retardation value Ro at a wavelength of 590 nm in the front direction (0°). The results are shown in FIG. 2.

### Example 15

By the same operation as in Example 12 except that cellulose n-octanate synthesized in Example 8 was dissolved in chloroform to be a 20% by weight solution of polymer, a film was prepared. This film was cut out in rectangles, with the both ends fixed, stretched until reaching about 4 times of the original length under a condition of 95° C. to obtain a retardation film of the present invention (thickness: 58 μm, retardation value at 590 nm: 280 nm). The slow axis of this retardation film was orthogonal to the stretching direction.

### Example 16

Cellulose (produced by Miki & Co., Ltd.) was impregnated in dimethylacetoamide to obtain dimethylacetamide-impregnated cellulose having a cellulose content of 53.0%. Next, after 41.5 g of lithium chloride was added to 500 mL of dimethylacetoamide and stirred at 80° C. until complete dissolution, 10 g of dimethylacetamide-impregnated cellulose was added thereto. While stirring at 50° C., 19.2 g of n-octanoyl chloride was added thereto and the temperature was raised again to 80° C., followed by stirring for 3.5 hours. The stirring was stopped and the reaction content was poured in 1000 mL of water to crystallize cellulose n-octanate. After collection by filtration, it was washed with 1000 mL of 50% water-containing methanol. Further, a solid content obtained by washing twice with 300 mL of methanol was vacuum-dried to obtain 15.4 g of white powder of cellulose n-octanate. The degree of substitution (number of substitution by n-octanate group per one cellulose monomer unit) was determined, resulting in 2.5. The degree of substitution of the cellulose n-octanate was calculated form the ratio of the peak area of seven hydrogens and the peak area of three hydrogens of an end methyl group of an octanoyl group in one cellulose monomer unit, using a NMR (300 MHz, manufactured by Varian, Inc.).

### Example 17

To 27 g of cyclopentanone, 3 g of cellulose n-octanate synthesized in Example 16 was added, and heated at 60° C. for dissolving to be a 10% by weight solution. After this solution was cooled to room temperature, 0.08 g of a 1% by weight solution of dibutyltin dilaurate-cyclopentanone and 0.1 g of 2-methacryloyloxyethylisocyanate were added and this solution was stirred at 25° C. for 1 hour, further, followed by stirring at 60° C. for 1 hour. The stirring was stopped and the reaction content was poured in 400 mL of water to crystallize cellulose ester having a polymerizable group. After collection by filtration, a solid content obtained by washing with 200 mL of methanol was dried at atmospheric pressure at 30° C. to obtain 4.6 g of white powder of cellulose ester having a polymerizable group. This compound does not turn to a solution but gelatinized at concentration of 10% with cyclopentanone, and can be dissolved to be a cyclopentanone solution at approximately 5.7%. In the example, by the same procedure using cellulose n-decanate obtained in Example 9 (degree of substitution: 2.48) or cellulose n-dodecanate obtained in Example 10 (degree of substitution: 2.16) instead of cellulose n-octanate, similarly, cellulose ester having a polymerizable group corresponding to each cellulose ester can be obtained.

### Example 18

The cellulose ester having a polymerizable group synthesized in Example 17 (cellulose n-octanate having a polymerizable group) was dissolved in chloroform to be a 12% by weight solution. This solution was coated on a releasing film (PET3801, manufactured by Lintec Corp.) using a comma coater and dried at 40° C. to remove a solvent, followed by delamination form the releasing film to prepare a cellulose derivative film. This film was subjected to photoirradiation treatment. The photoirradiation was performed 4 times under the conditions that the total quantity of the radiation performed by one photoirradiation cycle on the film surface using a 4 kW halogen lamp is 379 mJ/cm². This film was cut out in rectangles, with the both ends fixed, stretched until reaching about 2 times of the original length under a condition of 95° C. and cooled to room temperature to obtain a transparent retardation film of the present invention. The change in the retardation value when the retardation film was tilted to the slow axis and the fast axis directions respectively to 50°, that is, visible angle characteristics of the retardation film was determined, using an automatic birefringence meter (KOBRA-21ADH, manufactured by Oji Scientific Instruments Co., Ltd.) to calculate Rn/Ro, the ratio of the retardation value Rn at a wavelength 590 nm in a tilt angle n° to the retardation value Ro at a wavelength of 590 nm in the front direction (0°). The results are shown in FIG. 2. In this connection, the slow axis of this retardation film was orthogonal to the stretching direction.

### Example 19

The retardation film of the present invention prepared in Example 12 was warmed on a hot-stage microscopy (manufacture by Mettler-Toledo K.K.) to 200° C., and the film did not melt even at 160° C. It was checked with eyes that the film had not melted at all. And, in a closed system with aluminum, the temperature was raised from 40° C. to 200° C. using a differential scanning calorimeter (manufactured by Seiko Instruments Inc.), however a significant heat absorption peak to be observed during melting was not observed.

### Example 20

The retardation film of the present invention prepared in Example 13 was tested by the same operation as in Example 19, and the film did not melt even at 160° C. Also, the same test as in Example 19 was conducted using a differential scanning calorimeter (manufactured by Seiko Instruments Inc.), however a significant heat absorption peak to be observed during melting was not observed.

### Example 21

The retardation film of the present invention prepared in Example 14 was tested by the same operation as in Example 19, and the film did not melt even at 160° C.

### Example 22

The retardation film of the present invention prepared in Example 18 was cut 10 mm×50 mm, and stretched in a circumstance of 25° C. at a stretching speed of 20 mm/minute using a Tensilon (UTM-I-2500, manufactured by Baldwin Technology Company, Inc.), resulting in that the tearing strength was 424 kg/cm².

### Example 23

The retardation film of the present invention prepared in Example 1 and a polarizing film having a thickness of 180 μm (SKN18243T, manufactured by Polatechno Co., Ltd.) were laminated to each other with an acrylic type pressure-sensitive adhesive so that the slow axis of the retardation film of the present invention and the absorption axis of the polarizing film form an angle of 45 degrees, to prepare a circularly polarizing film of the present invention. This circularly polarizing film has a thickness of 277 μm. Next, this circularly polarizing film was placed on a mirror and observed about anti-reflection effect on the mirror surface, resulting in that the circularly polarizing film of the present invention turned deep black color and had a significant anti-reflection effect.

### Example 24

The retardation film of the present invention prepared in Example 2 was immersed in a 6N potassium hydroxide aqueous solution at 60° C. for 15 minutes, and then washed sufficiently with water. Subsequently, it was dried at 30° C. for 30 minutes to obtain a retardation film of the present invention with the surface layer subjected to saponification treatment. The contact angle of water to this film surface was 15°. Next, using a polyvinyl alcohol adhesive (NH26, manufactured by Nippon Synthetic Chemical Industry Co., Ltd.), the retardation film of the present invention subjected to saponification treatment was laminated on the polarizing element side of a polarizing film (UDN10243T, manufactured by Polatechno Co., LTD.) having a thickness of 100 μm which had a support film on only one side of the polarizing element, in such an arrangement that the absorption axis of the polarizing film and the slow axis of said retardation film had an angle of 45°, to obtain a circularly polarizing film of the present invention. The resulting circularly polarizing film had a thickness of 185 μm. This film was evaluated similarly to Example 23, resulting in that the circularly polarizing film of the present invention turned deep black color and had a significant anti-reflection effect.

### Example 25

In the same manner as in Example 13 except that cellulose n-decanate described in Example 9 was used and the stretching temperature was 70° C., a retardation film of the present invention was prepared. The thickness was 102 μm and the retardation at a wavelength of 550 nm was 135 nm. This film was immersed in a 6N potassium hydroxide aqueous solution at 60° C. for 10 minutes, and then washed sufficiently with water. Subsequently, it was dried at 30° C. for 30 minutes to obtain a retardation film of the present invention with the surface layer subjected to saponification treatment. The contact angle of water to this film surface was 50°. Next, using a polyvinyl alcohol adhesive (NH26, manufactured by Nippon Synthetic Chemical Industry Co., Ltd.), the retardation film of the present invention subjected to saponification treatment was laminated on the polarizing element side of a polarizing film (UDN10143P, manufactured by Polatechno Co., LTD.) having a thickness of 100 μm which had a support film on only one side of the polarizing element so that the absorption axis of the polarizing film and the slow axis of said retardation film had an angle of 45°, followed by heating at 70° C. for 10 minutes to obtain a thin type wide visible angle circularly polarizing film which is one embodiment for a circularly polarizing film of the present invention. This film had a whole thickness of 202 μm and a sufficient adhesiveness between each film. Next, this circularly polarizing film was placed on a mirror and observed about anti-reflection effect on the mirror surface, and it was found that the circularly polarizing film of the present invention had almost the same anti-reflection effect as in the front direction even when observed from any direction and excellent visible angle characteristics.

### Example 26

Using the cellulose ester having a polymerizable group described in Example 17, a retardation film of the present invention was prepared in the same manner as in Example 18. The thickness was 127 μm and the retardation at a wavelength of 550 nm was 279 nm. Next, using an acrylic type pressure-sensitive adhesive, a polarizing film (SKN18242P, manufactured by Polatechno Co., LTD.) and the retardation film of the present invention were laminated to each other in such an arrangement that the absorption axis of the polarizing film (the stretching direction of the polarizing element) and the fast axis of the retardation film of the present invention (the stretching direction of said film) are parallel to each other, to obtain a wide visible angle polarizing film which is one embodiment for an optical film of the present invention. An example of the wide visible angle polarizing film is shown in 4-2 of FIG. 4.

### Example 27

Using cellulose n-octanate described in Example 11, a retardation film of the present invention was prepared in the same manner as in Example 15. The thickness was 55 μm and the retardation at a wavelength of 550 nm was 271 nm. Using this film, a retardation film of the present invention with its surface layer subjected to saponification treatment was obtained by the same operation as in Example 25. Next, using a polyvinyl alcohol adhesive (NH26, manufactured by Nippon Synthetic Chemical Industry Co., Ltd.), the retardation film of the present invention subjected to saponification treatment was laminated on the polarizing element side of a polarizing film (UDN10143P, manufactured by Polatechno Co., LTD.) having a thickness of 100 μm which had a support film on only one side of the polarizing element, in such an arrangement that the absorption axis of the polarizing film (the stretching direction of the polarizing element) and the slow axis of said retardation film(the stretching direction of said film) were parallel to each other, followed by heating at 70° C. for 10 minutes to obtain a thin type wide visible angle polarizing film which is one embodiment for a optical film of the present invention. The resulting film had a whole thickness of 155 μm and sufficient adhesiveness between each film.

Next, a thin type wide visible angle polarizing film which is one embodiment for an optical film of the present invention and another polarizing film (SKN18242P, manufactured by Polatechno Co., Ltd.) were laminated to each other so that the absorption axis of the thin type wide visible angle polarizing film and the absorption axis of the polarizing film were orthogonal to each other (cross-Nicol) and the retardation film of the present invention was placed between the polarizing films. Next, the films in this condition were placed on a surface light source and evaluated on the degree of light passing through the film at the position tilted by about 50° from the front direction toward the direction of 45° from each absorption axis. As a result, it was found that when a wide visible angle polarizing film which is one embodiment for an optical film of the present invention was used, light pass was hardly observed at all and light was blocked at a wide visible angle.

### Example 28

Using a pressure-sensitive adhesive, the retardation film of the present invention prepared in Example 24 and a uniaxially stretched polycarbonate film having a retardation value of 120 nm were laminated to each other so that the fast axis (stretching direction) of the retardation film of the present invention and the slow axis (stretching direction) of the uniaxially stretched polycarbonate film were parallel to each other, to obtain a composite retardation film of the present invention. This retardation film and a polarizing film (SKN18243T, manufactured by Polatechno Co., Ltd.) in which the both surfaces of the polarizing element composed of polyvinyl alcohol in which iodine was adsorption-oriented were sandwiched by triacetyl cellulose films were laminated to each other with an acrylic type pressure sensitive adhesive so that the slow axis direction of this retardation film and the absorption axis of the polarizing film formed an angle of 45° to obtain a circularly polarizing film of the present invention. This film was evaluated similarly to Example 23, resulting in that it was proved that the reflection of the front direction was deep black color and a significant anti-reflection effect was provided. Further, the degree of reflection was similarly evaluated at the positions tilted by about 50° from the front direction toward up, down, left and right respectively and it was found that the reflection maintained deep black color and an achromatic characteristic and an anti-reflection effect even in a wide visible angle were provided.

### Example 29

In the same manner as in Example 13 except that the cellulose n-decanate described in Example 9 was use and the stretching temperature was 70° C., a retardation film of the present invention was prepared. The thickness was 105 μm and the retardation at a wavelength of 550 nm was 139 nm. Next, using this retardation film, a retardation film of the present invention with the surface layer subjected to saponification treatment was obtained by the same operation as in Example 25. Next, using an acrylic type pressure-sensitive adhesive, a retardation film (ESCENA, manufactured by Sekisui Chemical Co., Ltd.) having a retardation value in the film front direction of approximately 0 nm at 550 nm, a thickness of 50 μm, and a Rth (a product of difference between an average refractive index in a plane and a refractive index of the thickness direction, and thickness) of about 120 nm was laminated thereto to obtain a composite retardation film of the present invention.

### Example 30

Using cellulose ester having a polymerizable group described in Example 17, a retardation film of the present invention was prepared in the same manner as in Example 18. The thickness was 120 μm and the retardation at a wavelength of 550 nm was 264 nm. Next, using an acrylic type pressure-sensitive adhesive, said retardation film of the present invention and a retardation film of uniaxially stretched polycarbonate (thickness: 65 μm, retardation at a wavelength of 550 nm: 135 nm) were laminated to each other so that the slow axes crossed each other at an angle of 60° to obtain a composite retardation film of the present invention. Next, said composite retardation film of the present invention in which the above retardation value was about half a wavelength and a polarizing film (SKN18242P, manufactured by Polatechno Co., Ltd.) were laminated so that the absorption axis of the polarizing film and the slow axis of the retardation film of the present invention forms an angle of 75° to obtain an achromatic circularly polarizing film which is one embodiment for an optical film of the present invention. The film in this condition was placed on a mirror, and evaluated on the degree of reflection light passing through at the position tilted by about 50° from the front direction toward the direction of 45° from the absorption axis of the polarizing film. As a result, it was found that when a wide visible angle polarizing film which is one embodiment for an optical film of the present invention was used, light pass was hardly observed at all and light was blocked in a wide visible angle.

### Example 31

Using a polyvinyl alcohol adhesive (NH26, manufactured by Nippon Synthetic Chemical Industry Co., Ltd.), the retardation film of the present invention subjected to saponification treatment used in Example 29 was laminated on the polarizing element side of a polarizing film (UDN10143P, manufactured by Polatechno Co., LTD.) having a thickness of 100 μm which had a support film on only one side of the polarizing element so that the fast axis of said retardation film (the stretching direction of said film) and the absorption axis of said polarizing element (the stretching direction of the polarizing element) were parallel to each other, and heated at 70° C. for 10 minutes to obtain an optical film of the present invention. At this time, the polarizing element and the retardation film of the present invention were sufficiently bonded. Next, using an acrylic type pressure-sensitive adhesive, a retardation film (ESCENA, manufactured by Sekisui Chemical Co., Ltd.) having a retardation value in the film front direction of approximately 0 nm at 550 nm, a thickness of 50 μm and a Rth of about 120 nm was laminated on the above bonded retardation film side to obtain a composite optical film of the present invention. The whole thickness of this film was 280 μm.

### Example 32

By the same operation as in Example 25 except that the retardation film of the present invention subjected to saponification treatment obtained in Example 25 and a polarizing film were laminated in such an arrangement that the absorption axis of the polarizing film and the slow axis of said retardation film were orthogonal to each other, an optical film of the present invention was obtained. Using an acrylic type pressure-sensitive adhesive, a retardation film having a retardation value in the film front direction of about 0 nm at 550 nm, a thickness of 50 μm, no−ne=0.0024, and Rth=about 120 nm was laminated on the retardation film side of this optical film, to obtain an composite optical film of the present invention.

### Example 33

A polarizing film of a commercially available VA type liquid crystal display device was delaminated, and using an acrylic type pressure-sensitive adhesive, a polarizing film (SKN18243T, manufactured by Polatechno Co., LTD.) in which the both sides of the polarizing element were sandwiched by triacetyl cellulose films was laminated on the backlight side of the liquid crystal cell and the composite optical film prepared in Example 32 was laminated on the observation surface side of the liquid crystal cell so that the absorption axes of the polarizing film were orthogonal to each other, to obtain a liquid crystal display device of the present invention. With the backlight of this liquid crystal display device on, images in the black-displaying state was observed at the tilted position from the front direction of the display screen toward the direction of 45° from the absorption axis direction of the polarizing film, resulting in that the black state was maintained in spite of tilting by 85° and the visible angle was expanded.

### Example 34

The retardation film of the present invention prepared in Example 5 was subjected to saponification treatment by the same operation as in Example 24 to obtain a retardation film of the present invention having a contact angle of water in the film surface of 50° with the surface layer subjected to saponification treatment. Next, using a polyvinyl alcohol adhesive, the retardation film of the present invention subjected to saponification treatment was laminated on the polarizing element side of a polarizing film (UDN10243T, manufactured by Polatechno Co., LTD.) having a support film on only one side of the polarizing element and a thickness of 100 μm so that the absorption axis of the polarizing film (the direction parallel to the stretching direction) and the slow axis of said retardation film (the direction orthogonal to the stretching direction) were orthogonal to each other, to obtain an optical film of the present invention. The whole thickness of this optical film was 195 μm. Next, this optical film and another polarizing film (SKN18243T, manufactured by Polatechno Co., Ltd.) in which the both sides of the polarizing element were sandwiched by triacetyl cellulose films were laminated each other so that the absorption axis of the polarizing film composing this optical film and the absorption axis of the other polarizing film were orthogonal to each other (cross-Nicol) and the retardation film of the present invention composing the optical film was placed between the polarizing films. Next, the film in this condition was placed on a surface light source and evaluated on the degree of light passing through at the position tilted by about 50° from the front direction toward the direction of 45° from each absorption axis. As a result, it was found that when the wide visible angle polarizing film of the present invention was used, light pass was hardly observed at all and light was blocked in a wide visible angle.

### Example 35

A polarizing film of a commercially available VA type liquid crystal display device was delaminated, and using an acrylic type pressure-sensitive adhesive, a polarizing film (SKN18242P, manufactured by Polatechno Co., LTD.) in which the polarizing element was sandwiched by two triacetyl cellulose films was laminated on the backlight side of the liquid crystal cell and the optical film of the present invention prepared in Example 31 was laminated on the observation surface side of the liquid crystal cell so that the absorption axes of the polarizing films were orthogonal to each other and the retardation film side of the optical film of the present invention on the observation surface side are on the liquid crystal cell surface side, to obtain a liquid crystal display device of the present invention. With the backlight of this liquid crystal display device on, images in the black-displaying state was observed at the tilted position from the front direction of display screen toward the direction of 45° from the absorption axis of the polarizing film, resulting in that the black state was maintained in spite of tilting by 85° and the visible angle was expanded.

### Example 36

A polarizing film of a commercial available VA type liquid crystal display device was delaminated, and using an acrylic type pressure-sensitive adhesive, a polarizing film (SKN18242P, manufactured by Polatechno Co., LTD.) was laminated on the backlight side and a retardation film having a retardation value in the film front direction of about 0 nm at 550 nm, a thickness of 50 μm and a Rth of about 120 nm was laminated on the above bonded retardation film side of the wide visible angle polarizing film prepared in Example 26 which is one embodiment of optical films of the present invention, to obtain an optical film of the present invention on the observation surface side. Using an acrylic type pressure-sensitive adhesive, these films were laminated on the liquid crystal cell so that the absorption axes of the polarizing films are orthogonal to each other and the retardation film side of the optical film of the present invention on the observation surface side is bonded on the side of the liquid crystal cell plane, to obtain a liquid crystal display device of the present invention. With the backlight of this liquid crystal display device on, images in the black-displaying state were evaluated on the degree of light passing through at the position tilted by about 50° from the front direction toward the direction of 45° from the absorption axis direction of the display screen front direction, resulting in that the black state was maintained in spite of titling by 85° and the visible angle was expanded.

### Example 37

A mixed solution of 42.7 g of octanoic acid and 51.9 g of trifluoroacetic anhydride was heated to 50° C. and stirred. Next, 2.0 g of cellulose (produced by Miki & Co., Ltd.) was added in said mixed solution maintained at 50° C. and stirred for 6.5 hours. Next, the mixture was added in 200 mL of methanol to separate out the precipitate. This was separated by a suction filtration and washed twice with 200 mL of methanol, followed by vacuum-drying at 60° C. to obtain 5.4 g of white powder of cellulose n-octanate. The degree of substitution (number of substitution by n-octanate per one cellulose monomer unit) was determined, resulting in 2.94. The degree of substitution of the cellulose n-octanate was calculated similarly to Example 8, using a NMR (manufactured by Varian, Inc.)

### Example 38

By the same operation as in Example 12 except that cellulose n-octanate synthesized in Comparative Example 1 was dissolved in chloroform to be a 15% by weight solution, a film was prepared. This film was cut out in rectangles and the both ends on the short side were fixed, one of which was then uniaxially stretched in the longitudinal direction until reaching 4 times of the original length at 55° C., to obtain a retardation film of the present invention. The thickness of this retardation film was about 77 μm. Next, using an automatic birefringence meter (KOBRA-21ADH, manufactured by Oji Scientific Instruments Co., Ltd.), the retardation value at 590 nm was determined resulting in the retardation value at 590 nm was 452 nm.

### Example 39

The retardation film prepared in Comparative Example 2 was tested by the same operation as in Example 19, and it was checked with eyes that when warmed on a hot-stage microscopy (manufactured by Mettler-Toledo k.k.), the film began melting at 94° C. and melted completely at about 97° C. Also, the same test as in Example 19 was conducted using a differential scanning calorimeter (manufactured by Seiko Instruments Inc.), and when the film was warmed from 40° C. to 200° C. in a closed system with aluminum, a significant heat absorption peak to be observed during melting was observed at 81.5° C.

### Example 40

Cellulose n-octanate synthesized in Example 16 was dissolved in chloroform to be a 15% by weight solution, and this solution was coated on a releasing film (PET3801, manufactured by Lintec Corp.) using a comma coater and dried at 40° C. to eliminate the solvent, followed by delaminating from the releasing film to prepare a film. This film was cut out in rectangles, with the both ends on the short side fixed, stretched until reaching about 2 times of the original length under a condition of 95° C. and cooled to room temperature to obtain a retardation film of the present invention. And the retardation film was measured using an automatic birefringence meter (KOBRA-21ADH, manufactured by Oji Scientific Instruments Co., Ltd.), resulting in that the slow axis of this retardation film was orthogonal to the stretching direction.

### Example 41

The retardation film of the present invention prepared in Example 40 was stretched by the same operation as in Example 40, resulting in the tearing strength was 327 kg/cm².

### Comparative Example 1

To 25 g of cyclopentanone, 2.5 g of cellulose n-octanate synthesized in Example 16 was added and heat-dissolved at 60° C. After this solution was cooled to room temperature, 0.8 g of a 1% by weight dibutyltin dilaurate-cyclopentanone solution and 0.1 g of 2,4-tolylene diisocyanate were added thereto and stirred at 25° C. for 1 hour, followed further by stirring at 60° C. for 1 hour. The stirring was stopped and the reaction content was poured in 300 mL of water to crystallize the cellulose derivative. After collection by filtration, a solid content obtained by washing with 200 mL of methanol was dried at atmospheric pressure at 30° C. to obtain a cellulose derivative. This cellulose derivative was colored with pale yellow.

### Comparative Example 2

The cellulose derivative synthesized in Comparative Example 1 was dissolved in toluene to be a 10% by weight solution, and this solution was coated on a releasing film (PET3801, manufactured by Lintec Corp.) using a comma coater and dried at 70° C. to remove the solvent, followed by delaminating from the releasing film to prepare a film. This film was cut out in rectangles, with the both ends on the shot side fixed, stretched until reaching about 2 times of the original length under a condition of 95° C. to obtain a retardation film, which was colored with pale yellow.

### Comparative Example 3

In the same manner as in Example 23 except that a quarter wavelength retardation film produced from polycarbonate (the retardation value at a wavelength of 550 nm was 141 nm) was used, a circularly polarizing film was prepared and its anti-reflection effect was observed, resulting in that the film was dark purple color and did not have a sufficient anti-reflection effect.

### Comparative Example 4

Using an acrylic type pressure-sensitive adhesive, a retardation film, in which polycarbonate was uniaxially stretched, having a thickness of 65 μm and a retardation of 135 nm at a wavelength of 550 nm, instead of the retardation film of the present invention in Example 25, and a polarizing film (SKN18242P, manufactured by Polatechno Co., LTD.) in which the polarizing element was sandwiched by two triacetyl cellulose films were laminated so that the slow axis of the retardation film and the absorption axis of the polarizing film had an angle of 45°, to prepare a circularly polarizing film. This circularly polarizing film had a whole thickness of 270 μm. Next, this circularly polarizing film was evaluated similarly to Example 25, resulting in that, compared with two cases, the case of the front direction and the case of tilting from the front direction, the anti-reflection effect was reduced in the case of tilting from the front direction and the visible angle characteristics were inferior.

### Comparative Example 5

By the same operation as in Example 27 except that a polarizing film (SKN18242P, manufactured by Polatechno Co., LTD.) (the polarizing film had a thickness of 180 μm) was used instead of the wide visible angle polarizing film described in Example 27 which is one embodiment for an optical film of the present invention, when the absorption axes were orthogonal to each other the degree of light passing through was evaluated at the position tilted by about 50° from the front direction toward the direction of 45° from each absorption axis. As a result, in the direction of 45° from each absorption axis, light passed through along with tilting from the front direction and the visible angle characteristics were inferior.

### Comparative Example 6

By the same operation as in Example 32 except that a polarizing film (SKN18243T, manufactured by Polatechno Co., LTD.) in which the both sides of the polarizing element were sandwiched by triacetyl cellulose films was also used on the observation surface side, a liquid crystal display device was prepared. The liquid crystal display device was evaluated similarly to Example 32, resulting in that light passed through drastically from around the position tilted by about 40° and the black state was not able to be maintained.

### Comparative Example 7

A triacetyl cellulose film (TD80UF, manufactured by Fuji Photo Film Co., Ltd., thickness: about 80 μm) was uniaxially stretched at 210° C. until reaching 1.8 times of the original length in the same manner as in Example 1. The thickness of the resulting retardation film was 77 μm, and the retardation value was determined similarly to Example 1, resulting in that the retardation value at 590 nm was 77 nm. And, the refractive index of the resulting retardation film was: nx=1.4875, ny=1.4885, and nz=1.4874. Further, the film was purified to eliminate plasticizer and ultraviolet absorber, and the degree of substitution was determined by the same operation as in Example 1, resulting in that the degree of substitution was 2.9.

### Comparative Example 8

By the same operation as in Example 34 except that two polarizing films (SKN18243T, manufactured by Polatechno Co., LTD.) in which the both sides of the polarizing element were sandwiched by triacetyl cellulose films were used instead of the optical film of the present invention in Example 34, the degree of light passing through in the case of such alignment that the absorption axes of the polarizing elements were orthogonal to each other was evaluated. As a result, it was found that light almost passed through and the effect to block light was drastically reduced.

### Comparative Example 9

By the same operation as in Example 36 except that a polarizing film (SKN18242P, manufactured by Polatechno Co., LTD.) was used instead of a wide visible angle polarizing film obtained in Experiment 36 which is one embodiment for an optical film of the present invention, a liquid crystal display device was prepared. This liquid crystal display device was evaluated similarly to Example 36, resulting in that light pass through along with tilting and the black state was not able to be maintained.

### Comparative Example 10

A retardation film produced from polycarbonate subjected to uniaxially stretching which was used in Comparative Example 5 was laminated on a polarizing film (SKN18242P, manufactured by Polatechno Co., LTD.) in which the polarizing element was sandwiched by two triacetyl cellulose films so that the fast axis of said retardation film (the stretching direction of said film) and the absorption axis of said polarizing element (the stretching direction of the polarizing element) were parallel to each other, and then a retardation film (ESCENA, manufactured by Sekisui Chemical Co., Ltd.) having a retardation value in the film front direction of about 0 nm at 550 nm, a thickness of 50μ m and a Rth of about 120 nm was laminated on the polycarbonate retardation film side using acrylic type pressure-sensitive adhesive, to prepare a film. The whole thickness of this film was 345 μm. Using this film also on the observation surface side, a liquid crystal display device was prepared by the same operation as in Example 35. This liquid crystal display device was evaluated similarly to Example 35, resulting in that light passed through along with tilting and the black state was not able to be maintained.

Judging from FIG. 1, it is found that, compared Examples 1 and 2 with Comparative Example 7, the retardation film of Comparative Example 7 has an achromatic property but shows ny>nx>nz, while the retardation film of the present invention is a retardation film which shows nx>ny>nz and has an achromatic property. And judging from the results of Examples 23 and 24 and Comparative Example 3, it is found that the circularly polarizing film of the present invention has an excellent anti-reflection effect. Further, judging from the result of Example 28, the circularly polarizing film using the composite retardation film of the present invention has not only an excellent anti-reflection effect but also improved visible angle characteristics. Also, judging from the result of Example 33, the visible angle characteristics of a liquid crystal display device using the composite optical film of the present invention are extremely improved compared with that of Comparative Example 6. In addition, it is found that the retardation films of the present invention obtained in Examples 3 to 7 have biaxial characteristics showing nz≧ny>nx or ny>nz>nx even as these films were prepared by uniaxially stretching and wavelength dispersion characteristics in which the retardation value at the wavelength side longer than 550 nm is smaller than the retardation value at 550 nm and the retardation value at the wavelength side shorter than 550 nm is larger than the retardation value at 550 nm. Furthermore, it is found that, by comparing Example 34 with Comparative Example 8, the visible angle dependency of a polarizing film is dramatically improved by using the optical film of the present invention. Moreover, as will be found from Examples 24, 28 and 34, the retardation film of the present invention can be directly laminated to a polarizing element with an adhesive by saponification treatment and also can be a support for a polarizing film, so the whole thickness after lamination can be more reduced compared with a conventional lamination of a polarizing film in which the both sides of the polarizing element are sandwiched by support films and a retardation film by using a pressure-sensitive adhesive.

Further, as shown in Examples 19 to 21, the retardation film of the present invention obtained from the cellulose derivative of the present invention which was synthesized in Examples 8 to 10 and prepared in Examples 11 to 13 does not melt even when heated to 160° C. compared with Example 8 nor show a significant heat absorption peak to be appeared during melting, at no lower than 200° C. by differential scanning calorimeter, and therefore it is found that the heat resistance is improved. And, judging from the rate curve of tilt retardation in FIG. 2, it is found that it is possible to produce a retardation film having excellent visible angle characteristics with little change of retardation value in the case of tilting. Moreover, as shown in Examples 25, 27, 31 and 35, the retardation film of the present invention can be bonded to a polarizing element by saponification treatment, and therefore it is found that the retardation film of the present invention is significantly thinner and has visible angle characteristics improved compared with Comparative Example 4, 5 and 10. As described above, by using the retardation film of the present invention, a thinner elliptically, circularly or rotary polarizing film, a thinner wide visible angle polarizing film or a thinner optical film, having excellent heat resistance, can be obtained, and display devices using these films can impart thinning, high heat resistance and excellent visible angle characteristics.

Furthermore, as shown in Example 22, it is found that the retardation film composed of cellulose derivatives of the present invention obtained in Example 18 has superior film strength compared with Example 41. It is also found that the retardation film composed of cellulose derivatives of the present invention obtained in Example 18 dose not have such color as shown in Comparative Example 2 and has excellent transparency. And, as shown in Example 30, it is found that the optical film obtained from the retardation film of the present invention has visible angle characteristics improved. Further, as shown in Example 36, it is found that the liquid crystal display device comprising the retardation film of the present invention has visible angle characteristics improved, compared with Comparative Example 9. As described above, by using the retardation film of the present invention, an optical film having film strength improved and excellent transparency can be obtained, and each display device using these films can impart excellent visible angle characteristics.

1. The retardation film prepared by uniaxially stretching a cellulose derivative cross-linked with an aliphatic compound having a cross-linkable functional group and at least one or more functional groups reactable to a residual hydroxyl group of a cellulose ester where the degree of substitution of a hydroxyl group substituted by an aliphatic acyl group having 8 to 20 carbon atoms is not less than 1.0 and under 2.9 per one cellulose monomer unit, wherein a three dimensional refractive index at a measured wavelength of 590 nm satisfies the following Formula (1)
ny>nx Formula (1)
(wherein, nx represents a refractive index in stretching direction in plane of the retardation film and ny represents an refractive index in direction orthogonal to it in plane of the retardation film) and heat resistance is not less than 110° C.

2. The retardation film according to claim 1, wherein a ratio of retardation values of said retardation film determined at a measured wavelength of 590 nm satisfies the following Formula (2)
0.5≦R(50)/R(0)≦1.1 Formula (2)
(wherein, R (50) represents a retardation value when the retardation film is observed from a direction tilted by 50 degrees from the front toward the fast axis direction and R (0) represents the retardation value when a retardation film is observed from the front).

3. A composite retardation film prepared by laminating the retardation film according to claim 2 and another retardation film.

4. A circularly or elliptically polarizing film or a rotary polarizing film prepared by laminating the retardation film or the composite retardation film according to claim 1, 2, or 3 and a polarizing film.

5. An optical film prepared by laminating so that the slow axis of the retardation film according to claim 2 and the absorption axis or the penetration axis of the polarizing film are parallel or orthogonal to each other.

6. A composite optical film prepared by laminating a film where ne−no<0 (wherein no represents an average refractive index in a film plate, ne represents a refractive index in thickness direction), Rth calculated from Rth=(no−ne)×d (wherein d represents a thickness) is 100 to 300 nm and the retardation value in the front direction at 550 nm is 0 to 50 nm, the retardation film according to claim 1 or 2 and a polarizing film in this order so that the slow axis of the retardation film and the absorption axis of a polarizing element are orthogonal to each other.

7. A laminated film wherein a polarizing element comprising a polarizing film and the retardation film or the composite retardation film according to claim 1, 2 or 3 and another retardation film, are directly laminated.

8. An image display device provided with the circularly or elliptically polarizing film, the rotary polarizing film, the optical film or the composite optical film according to any one of claims 3 to 6.

9. The image display device according to claim 8, wherein the image display device is a liquid crystal display device.

10. A retardation film prepared by stretching a cellulose derivative cross-linked with an aliphatic compound having at least one or more functional groups reactable to a residual hydroxyl group of cellulose ester in which the degree of substitution of a hydroxyl group substituted by an aliphatic acyl group having 7 to 20 carbon atoms is not less than 1.0 and under 2.9 per one cellulose monomer unit and a cross-linkable functional group, wherein a three dimensional refractive index at a measured wavelength of 590 nm satisfies the following Formula (1),
ny>nx Formula (1)
(wherein, nx represents a refractive index in stretching direction in plane of the retardation film and ny represents an refractive index in direction orthogonal to stretching direction in plane of the retardation film).

11. The retardation film according to claim 10, wherein a ratio of retardation values of said retardation film determined at a measured wavelength of 590 nm satisfies the following Formula (2)
0.5≦R(50)/R(0)≦1.1 Formula (2)
(wherein, R (50) represents a retardation value when the retardation film is observed from a direction tilted by 50 degrees from the front toward the fast axis direction and R (0) represents a retardation value when the retardation film is observed from the front).

12. The retardation film according to claim 10, wherein a tearing strength is not less than 400 kg/cm².

13. A composite retardation film prepared by laminating the retardation film according to claim 10 and another retardation film.

14. An optical film prepared by laminating a polarizing film to the retardation film according to claim 10 or to a composite retardation film prepared by laminating said retardation film and another retardation film.

15. A liquid crystal display device provided with the retardation film, the composite retardation film or the optical film according to claim 10, 13 or 14.

16. The retardation film according to claim 10, wherein the cellulose derivative cross-linked with an aliphatic compound having a cross-linkable functional group is a cellulose derivative cross-linked by polymerization of a (meth)acryloyl group of a compound obtained by reacting an isocyanate group of an aliphatic compound having an isocyanate group and a (meth)acryloyl group to a residual hydroxyl group of cellulose ester.

17. The retardation film according to claim 16, wherein the aliphatic compound having an isocyanate group and a (meth)acryloyl group is (meth)acryloyloxy (C1 to C20) aliphatic hydrocarbon isocyanate.
